(19) United States
(12) Patent Application Publication
(10) Pub. No.: US 2022/0060430 A1
(43) Pub. Date: Feb. 24, 2022

(54) SYSTEMS AND METHODS OF DYNAMIC RESOURCE ALLOCATION AMONG NETWORKED COMPUTING DEVICES

(71) Applicant: ROYAL BANK OF CANADA, Toronto (CA)

(72) Inventors: Arun John MILTON, Toronto (CA); Adel Al NABULSI, Toronto (CA); Sonaabh SOOD, Toronto (CA); Seng TRIEU, Vaughan (CA); Manjari Paresh UDESHI, Oviedo, FL (US); Edison U. ORTIZ, Orlando, FL (US); Juan MARTIN SACRISTAN, Toronto (CA); Iustina-Miruna VINTILA, Bucharest (RO)

(21) Appl. No.: 17/466,870

(22) Filed: Sep. 3, 2021

Related U.S. Application Data
(63) Continuation-in-part of application No. 16/790,701, filed on Feb. 13, 2020.
(60) Provisional application No. 63/074,366, filed on Sep. 3, 2020.
(60) Provisional application No. 63/074,384, filed on Sep. 3, 2020.
(60) Provisional application No. 62/804,820, filed on Feb. 13, 2019.

(51) Int. Cl. H04L 12/911; H04L 12/923; H04L 12/927

(52) U.S. Cl. CPC H04L 47/781; H04L 47/762; G06N 20/00; H04L 47/822; H04L 47/808

(57) ABSTRACT

Systems and methods of dynamic resource allocation. The system may include a processor and a memory coupled to the processor. The memory stores processor-executable instructions that, when executed, configure the processor to: receive a signal representing a resource allocation request; determine a projected resource availability based on a resource model and a second data set including at least one data record unrepresented in batched historical data sets, the batched historical data sets including data records representing at least one of recurring or non-recurring resource allocations, and wherein the resource model is prior-trained based on the batched historical data sets; and generate an output signal for displaying the projected resource availability corresponding with the resource allocation request.

### CROSS REFERENCE TO RELATED APPLICATIONS

This application claims priority from U.S. provisional patent application No. 63/074,366, filed on Sep. 3, 2020, entitled “SYSTEMS AND METHODS OF DYNAMIC RESOURCE ALLOCATION AMONG NETWORKED COMPUTING DEVICES, and from U.S. provisional patent application No. 63/074,384, filed on Sep. 3, 2020, entitled “SYSTEMS AND METHODS OF DYNAMIC RESOURCE ALLOCATION AMONG NETWORKED COMPUTING DEVICES”, the entire contents of which are hereby incorporated by reference herein.

This application is a continuation-in-part of co-pending U.S. patent application Ser. No. 16/790,701, filed on Feb. 13, 2020, entitled “SYSTEM AND METHOD FOR DYNAMIC TIME-BASED USER INTERFACE”, which claims all benefit, including priority of that and of U.S. provisional patent application No. 62/804,820, filed on Feb. 13, 2019, entitled “SYSTEM AND METHOD FOR DYNAMIC TIME-BASED USER INTERFACE”, the entire contents of which are hereby incorporated by reference herein.

### FIELD

Embodiments of the present disclosure generally relate to the field of data record management and, in particular, to systems and methods of dynamic resource allocation among networked computing devices.

### BACKGROUND

A resource pool may include one or more of currency, precious metals, computing resources, or other types of resources. Computing systems may be configured to execute data processes to allocate resources among data records associated with one or more entities. Such data records may be stored at one or more disparate data source devices, such as at disparate banking institutions, employer institutions, retail entities, or the like.

### SUMMARY

Embodiments of the present disclosure are directed to systems and methods of adaptively allocating resources of a resource pool associated with a user identifier. The systems may provide interactive or dynamically provided graphical user interfaces for allocation resources associated with networked computing devices. In some embodiments, the graphical user interface may receive signals associated with prospective resource allocations and, in response, dynamically provide feedback associated with projected aggregate resource availability associated with one or more time periods. In some embodiments, the projected aggregate resource availability may be represented based on interactive graphical user interface elements. Embodiments of the present disclosure may associate projected resource availability with graphical user interface elements for providing near-real time resource allocation projections.

As a non-illustrating example, a resource pool associated with a user, Jane, may include monetary resources among one or more banking accounts, investment accounts, or other resource sources. When the user desires to purchase a product from a retailer in exchange for a quantity of currency, systems and methods may conduct operations for executing data processes to allocate the currency to a data record associated with the retailer. In some situations, the user determines whether to purchase the product based at least on (1) targeted resources to complete the product purchase (e.g., price) or (2) how much monetary resources may currently be available to the user at the present time (e.g., bank account balance today).

In some situations, allocating resources based predominately on a targeted resource allocation value (e.g., price) and a static overall value of a resource pool at a present time associated with the user may cause a deficiency in the resource pool at a later time for existing scheduled recurring or non-recurring transactions. For example, without considering future scheduled recurring transactions (e.g., home utility bills, mobile telephone bills, etc.), Jane's purchase of a sporting good product may leave Jane with a shortfall of monetary resources to pay already scheduled recurring transactions.

As another non-limiting example, a computing device that allocates a finite quantity of memory resources for a non-recurring operation (e.g., playback of a multimedia file) without regard for regularly scheduled recurring computing operations (e.g., operating system background processes) may cause the computing device to have a memory allocation deficiency at a later time.

Thus, it may be beneficial to provide systems and methods of adaptively allocation resources based on projected resource liquidity positions. In some embodiments of the present disclosure, systems may be configured to determine a projected resource availability to provide a quantitative measure representing an effect of a prospective resource allocation on an overall resource liquidity position of the resource pool. The projected resource availability may provide a quantified assessment, thereby providing “sober second thought” information prior to executing a data process to allocate the prospective resource allocation (e.g., Jane purchasing a sporting good product in exchange for digital currency).

In some situations, systems may determine the projected resource liquidity position based on static resource data assumptions. Such static resource data assumptions may not be configurable. For instance, Jane's monetary resources associated with a retirement banking account may be factored into a determination of a resource liquidity position. However, in some situations, the retirement banking account may not be readily available resources and inclusion of the retirement banking account funds a resource liquidity position measure may misstate a resource liquidity position associated with a user.

Further, systems for determining the projected resource liquidity position may determine projected resource liquidity position at a given or set point in time. It may be beneficial to provide a user-configurable basis for determining the projected resource liquidity position. It may be beneficial to provide a user-configurable basis for identifying a future time as the basis for determining the projected resource liquidity position (e.g., determine Jane's resource liquidity position at the end of the week) if the prospective resource allocation was executed at a present time (e.g., if Jane were to purchase the sporting good product today).

In some embodiments, the prospective resource allocation data (e.g., proposed sporting good product purchase price) may be provided by a point-of-sale computing device and may include proposed transaction data (e.g., a proposed purchase transaction for the sporting good product) that is pending authorization from a user associated with a computing device. In some situations, it may be beneficial for systems to be configured to provide the projected resource liquidity position for illustrating effects of the proposed purchase transaction on the overall resource liquidity position on a near real-time basis.

In one aspect, the present disclosure provides a system that may include: a processor and a memory coupled to the processor. The memory may store processor-executable instructions that, when executed, configure the processor to: receive a signal representing a resource allocation request; determine a projected resource availability based on a resource model and a second data set including at least one data record unrepresented in batched historical data sets, the batched historical data sets including data records representing at least one of recurring or non-recurring resource allocations, and wherein the resource model is prior-trained based on the batched historical data sets; and generate an output signal for displaying the projected resource availability corresponding with the resource allocation request.

In another aspect, the present disclosure provides a method that may include: receiving a signal representing a resource allocation request; determining a projected resource availability based on a resource model and a second data set including at least one data record unrepresented in batched historical data sets, the batched historical data sets including data records representing at least one of recurring or non-recurring resource allocations, and wherein the resource model is prior-trained based on the batched historical data sets; and generating an output signal for displaying the projected resource availability corresponding with the resource allocation request.

In another aspect, a non-transitory computer-readable medium or media having stored thereon machine interpretable instructions which, when executed by a processor may cause the processor to perform one or more methods described herein.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the present disclosure.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 illustrates a system for adaptively allocating resources, in accordance with an embodiment of the present disclosure;

FIG. 2 illustrates a user interface for displaying resource availability associated with a user identifier of a client device, in accordance with an embodiment of the present disclosure;

FIG. 3 illustrates a method of adaptively allocating resources from a resource pool, in accordance with an embodiment of the present disclosure;

FIG. 4 illustrates dynamically changing interfaces as an interactive user interface element is adjusted to represent a targeted resource allocation, in accordance with embodiments of the present disclosure;

FIGS. 5A and 5B illustrate user interfaces, in accordance with embodiments of the present disclosure;

FIGS. 6A and 6B illustrate user interfaces, in accordance with embodiments of the present disclosure;

FIGS. 7A and 7B illustrate user interfaces, in accordance with embodiments of the present disclosure;

FIGS. 8A and 8B illustrate user interfaces, in accordance with embodiments of the present disclosure;

FIG. 9 illustrates a user interface for providing projected resource availability data messages, in accordance with an embodiment of the present disclosure;

FIG. 10 illustrates a user interface, in accordance with another embodiment of the present disclosure;

FIG. 11 illustrates an architecture diagram of a platform including a resource prediction system, in accordance with embodiments of the present disclosure;

FIG. 12 illustrates a block diagram of a platform including the resource prediction system, in accordance with embodiments of the present disclosure;

FIG. 13 illustrates an architecture diagram of a platform including a system for generating projected resource availability values, in accordance with embodiments of the present disclosure;

FIG. 14 illustrates a block diagram of a resource allocation system, in accordance with embodiments of the present disclosure;

FIG. 15 illustrates a flowchart of a method of predicting or forecasting future resource allocations or resource transactions of a user, in accordance with an embodiment of the present disclosure;

FIG. 16 illustrates a partial flow chart of operations of a method of predicting or forecasting future resource allocations associated with a user, in accordance with embodiments of the present disclosure; and

FIG. 17 illustrates a flowchart of a method, in accordance with embodiments of the present disclosure.

### DETAILED DESCRIPTION

Embodiments of the present disclosure are directed to systems and methods of adaptively determining resource availability among one or more resource portions of a resource pool. In some examples, a resource pool may include one or a combination of tokens, digital currency, precious metals, computing resources, or other types of resources. One or more data records may be associated with a resource pool, and the one or more data records may include data values associated with user identifiers, quantitative characteristics of the resource pool, or other characteristics associated with the resource pool.

In some embodiments, a resource pool may include one or more of currency, precious metals, computing resources, or the like associated with one or more resource sources, such as systems associated with financial institutions, credit providing institutions, employers, utility service providers, or other resource providing entity.

To illustrate, an indication of aggregate resource availability associated with a user identifier (e.g., identifying Jane) may represent a liquidity position of Jane. For example, an indication of Jane's available digital currency (e.g., cash or sellable assets on hand) among Jane's banking-related accounts may represent Jane's liquidity position at a given point in time. In some embodiments, the indication of aggregate resource availability associated with Jane may be based on an aggregation of resource availability from a plurality of disparate banking institutions. A system may be configured to aggregate resource availability data from the plurality of disparate banking institutions associated with Jane and may be configured to determine Jane's liquidity position in near real-time.

In some examples, a determined liquidity position (e.g., cash or sellable assets on hand) may be based on a function of available assets and future resource allocations, such as periodic salary payments to Jane, business revenue attributable to Jane, debt reducing payment obligations, periodic bill payments, non-periodic payments, or other recurring or non-recurring resource transactions that may add or subtract from the resource pool associated with Jane.

In some situations, it may be beneficial to provide systems for providing Jane's prospective liquidity position in response to proposed resource transactions, such as proposed purchases or resource savings by Jane.

In some situations, it may be beneficial to provide such prospective liquidity position based on a user configurable time-line. For instance, Jane may appreciate knowing Jane's liquidity position in 2 weeks' time in the event that Jane conducts a resource transaction tomorrow.

A system for managing resource pools may conduct computer-implemented operations for accessing one or a plurality of data source devices. For example, the system may conduct operations for requesting account balance data from one or more data devices associated with financial institutions, bill payment data from one or more data devices associated with utility institutions (e.g., telecommunications provider for Internet, cellular telephone, etc.), pre-paid/loyalty account data from one or more data devices associated with merchants (e.g., coffee shops, grocery stores, etc.), or other data devices associated with resource transactions that may add or subtract from the resource pool associated with Jane.

In some situations, the system for managing resource pools may receive data sets from the data devices at periodic time intervals (e.g., once daily, once weekly, or other time period). When the system conducts operations to receive data sets (e.g., bank account statements, utility invoices, etc.) at fixed intervals of time, the system may be limited to determining aggregate resource availability data that is solely as current as the last time stamp of the received data sets. It may be beneficial to provide systems and methods configured to provide a user, such as Jane, with features for determining Jane's aggregate resource availability data at a user stipulated point-in-time.

In some situations, the system may be configured to determine aggregate resource availability data associated with a user based on one or more static assumptions, such as non-representative categorization of particular data sets or time. It may be beneficial to provide systems and methods to determine aggregate resource availability data based on configurable parameters that may otherwise incorrectly include static data assumptions.

For instance, some embodiments of systems may be configured to receive customizable input from Jane that Jane's upcoming anticipated credit card invoice should not be taken into account when determining projected resource availability data, at least, because Jane may be expecting a credit transaction on the credit card account (e.g., due to a significant product return at a store). The product return/credit transaction may not yet be reflected on a credit card account invoice.

In some situations, it may be beneficial to provide systems and methods to determine aggregate resource availability data at user-selectable points-in-time, and where the user-selectable points-in-time may be forward-looking for resource projection planning or backwards-looking for historical analysis.

Further, in some situations, it may be beneficial to provide systems and methods of providing, in substantially near-real time, projected resource availability analysis based on anticipated or targeted resource transactions, thereby providing an interactive experience at a client device for determining resource liquidity position in the event that the anticipated resource transaction is completed. In this example, a user, such as Jane, may interactively make a quantitatively informed decision, via a user interface provided by the client device, on whether to proceed with a proposed resource transaction based at least on a projected resource liquidity position.

Jane's resource pool may be based on an abundance of data sets representing resources and associated numerous networked resource processors (e.g., banking institution servers, etc.). In some situations, Jane may expediently making decisions on whether to conduct resource transactions (e.g., buy a product, set aside money in a retirement fund, etc.), but may require an understanding of Jane's liquidity position as one factor in the decision making process. For instance, Jane may be at a retail store contemplating a product purchase and may desire to understand Jane's liquidity position as one factor in the decision making process.

It may be impractical to displaying the abundant resource data sets on a display interface for Jane to analyze, at least, because the display interface of a computing device may be subject to limited display real estate and because it may not be feasible to analyze copious sets of data when Jane may need to make a resource transaction decision within a limited time period. It may be beneficial to provide user interfaces for adaptively receiving proposed resource transaction data and visually providing Jane's resource liquidity position on a display device having limited real estate.

Numerous features of systems and methods of determining resource availability for a resource pool and providing dynamic liquidity position feedback will be described in the present disclosure.

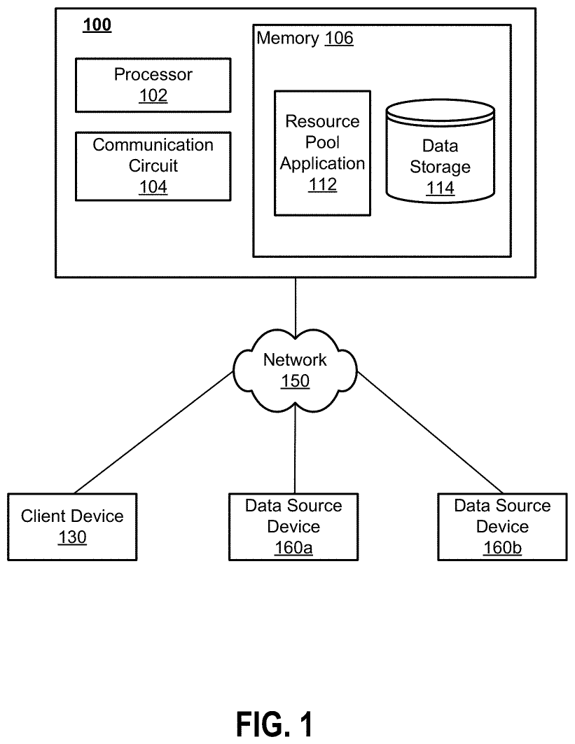

Reference is made to FIG. 1, which illustrates a system 100, in accordance with an embodiment of the present disclosure. The system 100 may transmit or receive data messages via a network 150 to or from a client device 130 or one or more data source devices, such as a first data source device 160a and a second data source device 160b. A single client device 130 and two data source devices are illustrated in FIG. 1; however, it may be understood that any number of client devices or data source devices may transmit or receive data messages to or from the system 100.

The network 150 may include a wired or wireless wide area network (WAN), local area network (LAN), a combination thereof, or other networks for carrying telecommunication signals. In some embodiments, network communications may be based on HTTP post requests or TCP connections. Other network communication operations or protocols may be contemplated.

The system 100 includes a processor 102 configured to implement processor-readable instructions that, when executed, configure the processor 102 to conduct operations described herein. For example, the system 100 may be configured to conduct operations for adaptively determining resource availability for a resource pool. In some examples, the processor 102 may be a microprocessor or microcontroller, a digital signal processing processor, an integrated circuit, a field programmable gate array, a reconfigurable processor, or combinations thereof.

The system 100 includes a communication circuit 104 configured to transmit or receive data messages to or from other computing devices, to access or connect to network resources, or to perform other computing applications by connecting to a network (or multiple networks) capable of carrying data.

In some embodiments, the network 150 may include the Internet, Ethernet, plain old telephone service line, public switch telephone network, integrated services digital network, digital subscriber line, coaxial cable, fiber optics, satellite, mobile, wireless, SS7 signaling network, fixed line, local area network, wide area network, or other networks, including one or more combination of the networks. In some examples, the communication circuit 104 may include one or more busses, interconnects, wires, circuits, or other types of communication circuits. The communication circuit 104 may provide an interface for communicating data between components of a single device or circuit.

The system 100 includes memory 106. The memory 106 may include one or a combination of computer memory, such as random-access memory, read-only memory, electro-optical memory, magneto-optical memory, erasable programmable read-only memory, and electrically-erasable programmable read-only memory, ferroelectric random-access memory, or the like. In some embodiments, the memory 106 may be storage media, such as hard disk drives, solid state drives, optical drives, or other types of memory.

The memory 106 may store a resource pool application 112 including processor-readable instructions for conducting operations described herein. In some examples, the resource pool application 112 may include operations for adaptively determining resource availability for a resource pool. For example, determined resource availability may represent a device user's resource liquidity position associated with banking or monetary currency resources.

The system 100 includes data storage 114. In some embodiments, the data storage 114 may be a secure data store. In some embodiments, the data storage 114 may store resource data sets received from data source devices (160a, 160b), data sets associated with historical resource transaction data, or other data sets for administering resource transactions among resource pools.

The client device 130 may be a computing device, such as a mobile smartphone device, a tablet device, a personal computer device, or a thin-client device. The client device 130 may be configured to operate with the system 100 for executing data processes to allocate targeted resource allocations to or from the user's associated resource pool; or to dynamically display a resource pool availability, in response to receiving a signal representing a prospective resource allocation by a user.

Respective client devices 130 may include a processor, a memory, or a communication interface, similar to the example processor, memory, or communication interfaces of the system 100. In some embodiments, the client device 130 may be a computing device associated with a local area network. The client device 130 may be connected to the local area network and may transmit one or more data sets to the system 200.

The data source devices (160a, 160b) may be computing devices, such as data servers, database devices, or other data storing systems associated with resource transaction entities. For example, the data source device 160a may be associated with a banking institution providing banking accounts to users. The banking institutions may maintain bank account data sets associated with users associated with client devices 130, and the bank account data sets may be a record of monetary transactions representing credits (e.g., salary payroll payments, etc.) or debits (e.g., payments from the user's bank account to a vendor's bank account).

In another example, the second data source device 160b may be associated with a vehicle manufacturer providing auto-financing to a user associated with the client device 130. Terms of the auto-financing may include periodic and recurring payments from a resource pool associated with the user (of the client device 130) to a resource pool associated with the vehicle manufacturer.

In some embodiments of the present disclosure, the system 100 may be configured to conduct operations for dynamically or adaptively determining projected resource availability (e.g., resource liquidity position) based on a targeted resource transaction (e.g., allocation to another resource pool of another entity) via a user interface within limited display real estate on a client device.

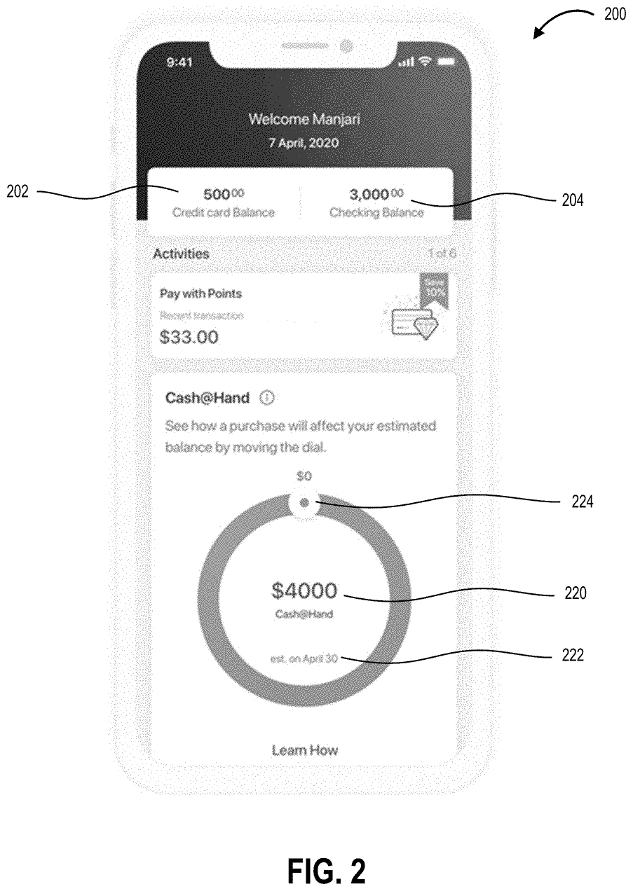

Reference is made to FIG. 2, which illustrates a user interface 200 for displaying resource availability associated with a user identifier of a client device, in accordance with an embodiment of the present disclosure. The user interface 200 may be included as a feature of a mobile banking application provided by a banking institution. The mobile banking application may be executed on a client device, such as a mobile smartphone device or the like.

In FIG. 2, the user interface 200 includes a text-based region showing a credit card balance 202 and a text-based region showing a banking account balance 204. The aforementioned text-based regions may be associated with the user identifier associated with a banking account customer.

The user interface 200 may include a resource liquidity position indicator 220 and a time-based indicator 222. In some examples, the resource liquidity position indicator 220 may provide an indication of an amount of money available for the user to spend (e.g., Cash@Hand) at a temporal reference point (e.g., on April 30) identified by the time-based indicator 222.

In FIG. 2, the text region shows a banking account balance 204 of $3,000 and the text region showing a credit card balance 202 of $500. Based solely on these resource-related data points and assuming that a user wishes to pay off credit card balances in full at the end of every invoice cycle, in some embodiments, operations may be conducted to determine that the resource liquidity position as $2,500. However, such a determination of liquidity position may be over-simplistic and may not take into account other recurring or non-recurring resource transactions by the user. It may be beneficial to provide user interfaces for dynamically or adaptively determining resource availability based on a plurality of resource data set portions that in combination provide an indication of a resource pool associated with a user.

The user interface 200 includes a resource liquidity position indicator 220 (e.g., Cash@Hand) based on a plurality of resource data set portions at an indicated time period indicator 222 (e.g., on “April 30”). In the present illustration, the resource liquidity position indicator 220 shows a resource liquidity position value of $4,000, which may be based on one or a combination of projections of numerous recurring or non-recurring resource transfers.

In some embodiments, the resource liquidity position value may be based on a plurality of potential or planned recurring resource allocations. Resource allocations may be resource allocations from a first resource pool to a second resource pool. For example, resource allocations may include transferring money from an employer's banking account to the user's banking account on a periodic basis, or transferring money from the user's chequing account to a retirement savings account (e.g., a non-liquid resource pool portion) on a periodic basis. Providing a resource liquidity position indicator 220 associated with the indicated time period indicator 222 provides a user with an indication of their liquidity position based on numerous resource sources at a point-in-time.

It may be beneficial to provide user interfaces for adaptively determining resource availability based on prospective resource allocations. In some embodiments, signals representing the prospective resource allocations may be based on input from a user of the computing device, or may be based on input from another computing device, such as a third-party point-of-sale terminal.

In some embodiments, the user interface 200 may include an interactive user interface element 224 adapted to receive an activation signal. The interactive user interface element 224 may be adapted to receive sliding user input along a substantially circular or elliptical path. The user interface 200 may be provided on a touchscreen display for receiving touch input, and a user may touch the interactive user interface element 224 and slide the user's finger along the substantially circular path to indicate a prospective resource allocation. Detected movement of the interactive user interface element 224 for indicating a prospective targeted resource allocation (e.g., prospective product purchase) may cause a projected resource availability (e.g., Cash@Hand) to dynamically be displayed along the circular path. The displayed user interface features along the circular path may be proportional to an amount of “Cash@Hand” resources projected as being available to the user.

In some embodiments, the user interface may receive user input based on detection of a user's finger at a location about the circular or elliptical path. Other forms of receiving user input along the circular or elliptical user interface path may be contemplated.

In some embodiments, the user interface 200 may be configured such that when a user places a finger on the interactive user interface element 224 for a predefined duration of time (e.g., akin to pushing down on the interactive user interface element 224), a first signal command may be transmitted to the system 100 (FIG. 1). Further, when the user slides their finger to move the interactive user interface element 224, a second signal command may be transmitted to the system 100 (FIG. 1). In the above examples, the user interface 200 may be configured to receive a plurality of signal types (e.g., touch-hold, touch-slide, touch-release, etc.) for providing commands to the system 100 or other applications described in the present disclosure. In some embodiments, a touchscreen device of the client device 130 may be associated with a coordinate system (e.g., X-Y Cartesian coordinate system), and detected user touches or relative movements in the x-axis or y-axis directions may be associated with commands to the system 100.

Accordingly, the present disclosure describes systems conducting operations for adaptively presenting a projected resource liquidity position, in response to signals associated with a targeted or prospective resource allocation.

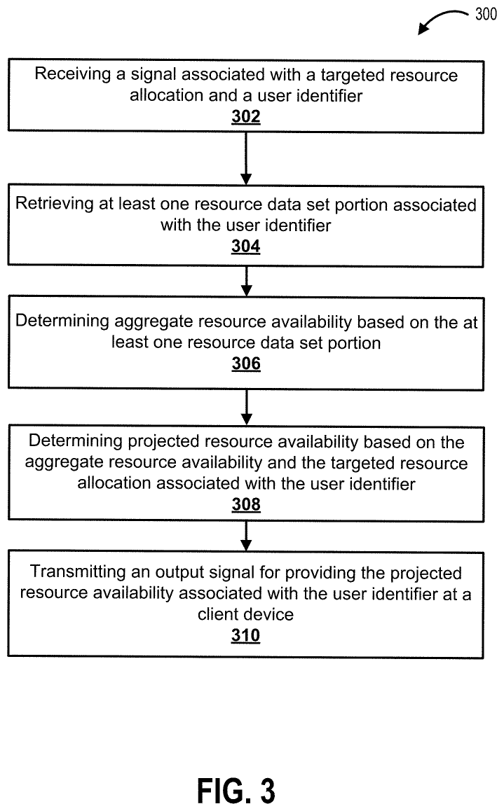

Reference is made to FIG. 3, which illustrates a flowchart of a method 300 of adaptively allocating resources of a resource pool, in accordance with an embodiment of the present disclosure. The method may be conducted by the processor 102 of the system 100 (FIG. 1). Processor-readable instructions may be stored in the memory 106 and may be associated with the resource pool application 112 or other processor readable applications not illustrated in FIG. 1. The method 300 may include operations, such as data retrievals, data manipulations, data storage, or the like, and may include other computer executable functions. In some embodiments, the method 300 may be conducted by a processor of the client device 130, and the client device 130 may transmit data messages to or from the data source devices.

To illustrate features of the present disclosure, embodiments of the system 100 associated with a banking institution will be described. The system 100 may be configured to provide banking operations to banking customers. The system 100 may be configured to transmit or receive data messages to or from the client device 130. The client device 130 may be associated with a banking customer user.

The client device 130 may include processor-readable instructions that, when executed, provide a user interface, such as the user interface 200 described with reference to FIG. 2. The user interface may be associated with a banking application and be configured to receive user input from the banking customer user. The user interface may be configured to display output to the banking customer user.

Further, the system 100 may be configured to transmit or receive data messages to or from one or more data source devices (160a, 160b). In some embodiments, the one or more data source devices may be computing devices associated with the banking institution, may be data devices associated with utility service providers (e.g., telecom companies, hydro-electric companies, etc. issuing invoices to the banking customer user), may be data devices associated with employers (e.g., paying payroll to the banking customer user), or other data devices that may be associated with data records pertinent to allocating resources.

In some embodiments, the system 100 may conduct the method 300 for adaptively determining resource availability of a resource pool associated with the banking customer. For instance, the method 300 may conduct operations for dynamically providing a liquidity position of the user based on one or more resource allocation portions from one or more data source devices (160a, 160b).

In some embodiments, the provided liquidity position of the user may be associated with a forward-looking period of time. For example, the provided liquidity position of the user may represent the user's “Cash©Hand” at time that is user selectable (e.g., at the end of the week, or specifically on Saturday). In some embodiments, the provided liquidity position of the user may based on a targeted or anticipated resource transaction. For instance, a targeted resource transaction may be a user's proposal to purchase a household appliance.

In the present example, dynamically providing a projected resource liquidity position on the condition that the user actually purchases the household appliance may provide the user with a sense of the change in liquidity position. The projected resource liquidity position may provide the user with information on whether the user can afford to spend on the household appliance, or with information on a projected resources (e.g., money) for other expenditures. In some situations, providing a visual indication to a user on a projected resource liquidity position may be a tool to assist the user with managing resource flow (e.g., cash flow).

At operation 302, the processor may receive a signal associated with a targeted resource allocation and a user identifier. The user identifier may be a unique username, pseudo identifier, or the like for associating signals with the banking customer. The targeted resource allocation may represent a user's proposal to conduct a resource allocation (e.g., pending purchase of a product or a service, plan to set aside money within a savings account, etc.).

In some embodiments, the signal may be generated based on touch input received at a touchscreen display of the client device 130. For instance, the touch input may be received on the user interface 200 (FIG. 2). The touch input may include user input associated with sliding the interactive user interface element 224 in a first direction. In the example user interface 200 of FIG. 2, the touch input may include sliding the interactive user interface element 224 in a substantially circular path by a distance that corresponds with the targeted resource allocation. For example, the user may slide the interactive user interface element 224 approximately ¼ of the circular path to indicate a targeted product purchase value of $1,100.

The signal associated with the target resource allocation may provide a basis for determining a projected resource availability in the event that a user associated with the targeted resource allocation provides user input to execute a data process to allocate that targeted resource allocation.

For example, a user at a brick-and-mortar store may provide user input (at the user interface 200) to indicate a pending point-of-sale transaction. Such a user input signal may represent a query on how the resource liquidity position may change in response to authorizing the pending point of sale transaction.

In some embodiments, the signal associated with the targeted resource allocation may include a signal representing a pending resource allocation value received from a point-of-sale terminal. For example, the client device 130 may detect a signal, via near-field communication from the point-of-sale terminal, representing a purchase authorization. The signal representing the purchase authorization may include the user identifier and the cost of the targeted product purchase value. The signal representing the purchase authorization may provide a basis for proactively providing a projected resource availability in the event that the user approves the purchase authorization (e.g., submits a personal identification number (PIN), provides a biometric input to signal approval, etc.). As will be disclosed, providing such projected resource availability data or notifications may provide the user of the client device 130 with an opportunity to consider whether any future resource deficiencies for that user may occur.

At operation 304, the processor may retrieve, from at least one networked resource processor, at least one resource data set portion associated with the user identifier. In some embodiments, the processor may retrieve from one or more of the data source devices (160a, 160b) one or more resource data set portions associated with the user identifier. In some embodiments, resource data set portions may include banking transaction data, payroll data, debt repayment data, utility invoices payment data, or other types of data associated with allocating resources to or from the user associated with the user identifier.

In some embodiments, the one or more resource data set portions may be real-time data as of the time of operations for retrieving the data. For instance, the one or more resource data set portions may be received on an “on-demand” basis, rather than a batch data retrieval that may occur at re-scheduled periods of time. By retrieving resource data set portions on an “on-demand” basis, accuracy in subsequent operations for determining projected resource availability may be increased.

In some embodiments, the one or more resource data set portions may be based on a combination of batch data retrieval (e.g., once or twice daily) and data sets updated on a substantial real-time basis (e.g., every minute or every 5 minutes)

At operation 306, the processor may determine aggregate resource availability based on the retrieved at least one resource data set portions. In some embodiments, the aggregate resource availability may include operations for adding the value of resources associated with the user identifier, subtracting the value of resources that may be associated resource transactions from that user to other entities, estimating the value of resources based on current market value, or other operations for determining the value of a plurality of sources of resources associated with the user identifier.

For example, the processor at operation 306 may determine a resource liquidity position of Jane at the current time. The resource liquidity position of Jane may include a combination of balances at one or more banking accounts, balances associated with credit card accounts, balances associated with service providers accounts, loyalty points accounts with one or more merchants, or any other balances representing resources that Jane may transfer to another entity in exchange for products or resources.

Referring again to FIG. 2, the determined resource liquidity position may be displayed as the resource liquidity position indicator 220. For instance, the determined resource liquidity position prior to execution of any data process to allocate the targeted resource allocation may be $4,000 (e.g., “Cash©Hand”).

At operation 308, the processor may determine a projected availability based on the aggregate resource availability and the targeted resource allocation associated with the user identifier. The projected resource availability may be based on an execution of a data process to allocate the targeted resource allocation. As an example, in the scenario that the targeted resource allocation represents a $1,100 proposed transaction or savings, the processor may determine the projected availability to be $2,900. The aforementioned scenario is a simplified example for disclosing features of embodiments described herein.

In some embodiments, the projected resource availability may be determined as of a specified date/time in the future (e.g., 3 days from today, etc.). In some situations, during the course of time leading to the specified future date/time, there may be scheduled recurring resource allocations associated with the user identifier. For instance, the user identifier may be associated with pre-authorized payments of home utility bills and, thus, the determined projected resource availability may be based on: (1) the targeted product purchase value of $1,100; (2) the pre-authorized payments scheduled to be allocated leading to the specified date/time in the future; or (3) other resource allocations that may include credits incoming resources (e.g., payroll payments) associated with the user identifier. In the present example, the processor, at operation 308, may determine projected resource availability based on a plurality of scheduled allocations at a future time, predicted allocations at a future time, or the targeted resource allocation identified at operation 302. Allocations at future times may, in some embodiments, be represented as time-series data from the one or more data source devices (160a, 160b).

At operation 310, the processor may transmit an output signal for providing the projected resource availability associated with the user identifier at the client device 130. The output signal may be associated with an update to the user interface 200 for displaying the “Cash©Hand” in response to the targeted resource allocation represented by sliding user input of the interactive user interface element 224.

In some embodiments, the processor may transmit the output signal within a threshold time from receipt of the signal associated with the targeted resource allocation. For example, the processor may transmit the output signal associated with the projected resource availability within 3 seconds of receiving the signal associated with the targeted resource allocation (e.g., operation 302). Other time thresholds for providing a response on targeted resource allocation may be used.

By providing timely feedback (e.g., in substantial real-time) regarding how the targeted resource allocation may change the user's resource liquidity position at a future point in time, the feedback may prompt the user to re-evaluate whether the targeted resource allocation may adversely affect the user's resource liquidity position (e.g., future purchasing power). In some situations, the timely feedback regarding the targeted resource allocation may reduce the likelihood of “buyer's remorse” by the user of the client device 130.

In some embodiments, the output signal for providing the projected resource availability may include a signal for providing haptic feedback representing at least one projected resource availability threshold. For example, the output signal may cause the client device 130 to provide mechanical vibrations via the client device 130 for indicating that executing the targeted resource allocation (e.g., going ahead with a product purchase) may transition the resource liquidity position to a low resource threshold. Other thresholds or pre-programed indications may be associated with the provided haptic feedback.

In some embodiments, the output signal for providing the projected resource availability may include a signal for displaying a non-textual user interface element representing the projected resource availability. The non-textual user interface may include a color gradient along the circular path of interactive user interface. The color gradient may include colors such as green, yellow, or red. The non-textual user interface may transition from green to yellow when the projected resource availability (e.g., Cash@Hand) decreases in value by 30%, and may transition from yellow to red when the projected resource availability decreased in value by 70% or more. The non-textual user interface may be provided at the client device 130 in combination with providing the resource liquidity position indicator 220.

In some embodiments, the thresholds during which the displayed color gradients may transition from one color to another color may be dynamic threshold values based on resource flow availability to provide requested resources to one or more entities (e.g., akin to a debt-service ratio). The dynamic threshold values may be based on historical or previous resource transactions in the past 2 weeks, based on identified income streams in the past month, or other resource data. In such examples, the dynamic user interface for providing the projected resource availability may be provided based on dynamic communication with the system 100 (FIG. 1) or based on operations of the resource pool application 112.

In some embodiments, a subset of operations for determining or providing the dynamic user interfaces may be conducted at the client device 130 on a substantially real-time basis, and a subset of operations may include communicating with the system 100 on a periodic basis for retrieving updated data sets or computationally-intensive data operations.

In some situations, it may be beneficial to provide user-configurable input interface elements for receiving a time signal representing a prospective time. The time signal representing the prospective time may be for determining the projected resource availability at a user-specified time. For example, referring again to FIG. 2, the time-based indicator 222 may be adapted to receive user input for modifying the time at which a resource liquidity position is requested. For instance, the time-based indicator 222 may be a user interface element that, when touched, is adapted to receive user input for specifying that a projected resource availability as of May 2^{nd} is sought. Thus, in some embodiments, the processor may be configured to determine the projected resource availability (e.g., Cash@Hand) by time-shifting the determined projected resource availability to the prospective time.

In some embodiments, the processor may receive a user input signal representing an option to disable one or more resource transaction categories for determining projected resource availability. As a non-limiting example, the user input signal may include input from the client device 130 for indicating that an existing credit card balance need not be factored in to determining the projected resource availability, or that upcoming expenses of a particular quantity need not be factored into determining the projected resource availability. In some situations, the user of the client device 130 may not plan on paying off the credit card balance of $500 and, thus, may desire that the anticipated payment of the credit card balance not be factored into determining the projected resource availability or Cash@Hand.

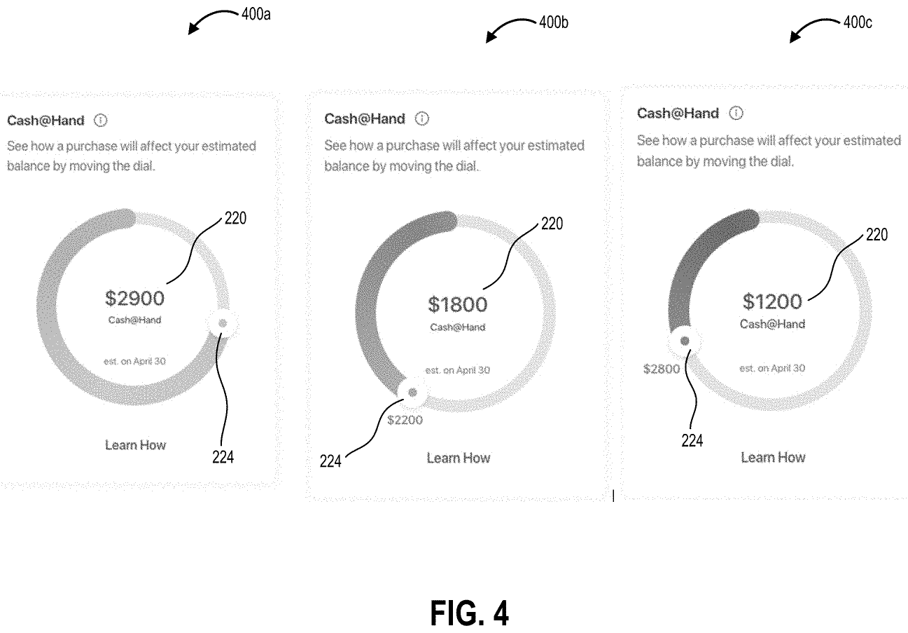

Reference is now made to FIG. 4, which illustrates dynamically changing output interfaces, such as a first state 400a, a second state 400b, and a third state 400c, of the user interface 200 of FIG. 2, in accordance with embodiments of the present disclosure.

In the first state 400a, the interactive user interface element 224 may represent a targeted resource allocation or prospective purchase of $1,100. In the second state 400b, the interactive user interface element 224 may represent a prospective purchase of $2,200. In the third state 400c, the interactive user interface element 224 may represent a prospective purchase of $2,600. As the quantity of the prospective purchase changes, the resource liquidity position indicator 220 may be dynamically updated to provide the projected resource availability associated with the respective prospective purchase value.

In some embodiments, the interactive user interface element 224 may include non-textual user interface elements, such as color gradients along the circular user interface element, indicating dynamically changing projected resource availability. For example, as the prospective purchase value increases, the color gradient representing the projected resource availability may change from shades of green, to yellow, to orange, or to red.

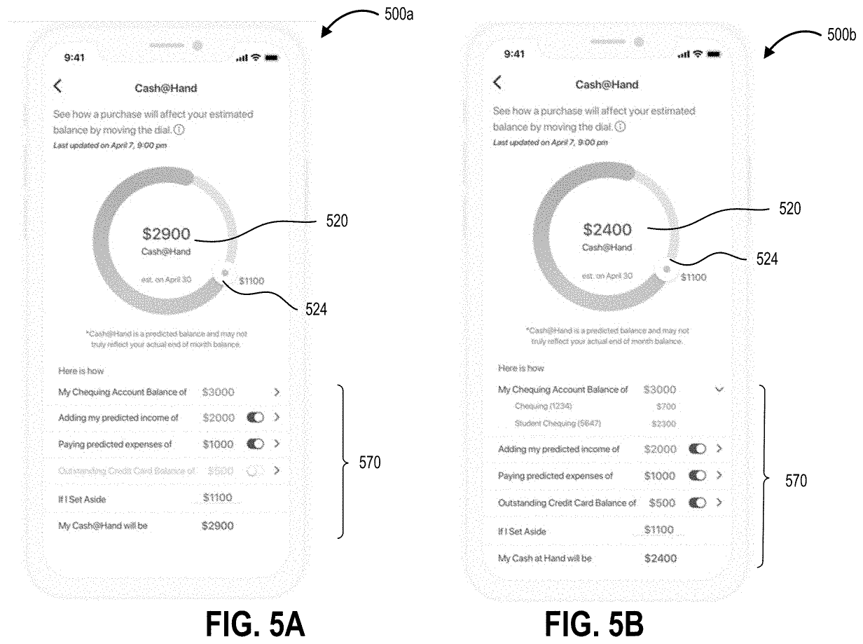

Reference is made to FIGS. 5A and 5B, which illustrate additional features of the user interfaces for providing projected resource availability at a client device, in accordance with embodiments of the present disclosure. In FIGS. 5A and 5B, the user interfaces (500a, 500b) include features similar to the user interface 200 of FIG. 2. For example, the user interfaces (500a, 500b) include resource liquidity position indicators 520 or interactive user interface elements 524 adapted to receive sliding user input representing a targeted resource allocation.

The user interfaces (500a, 500b) may include user-configurable input interface elements 570 representing one or more options to disable one or more resource transaction categories during operations for determining projected resource availability. In the illustrated example of FIGS. 5A and 5B, the client device may receive user input to include or exclude a “Credit Card balance of $500” from operations for determining the projected resource availability or Cash@Hand. Other user-configurable input interface elements 570 may be contemplated.

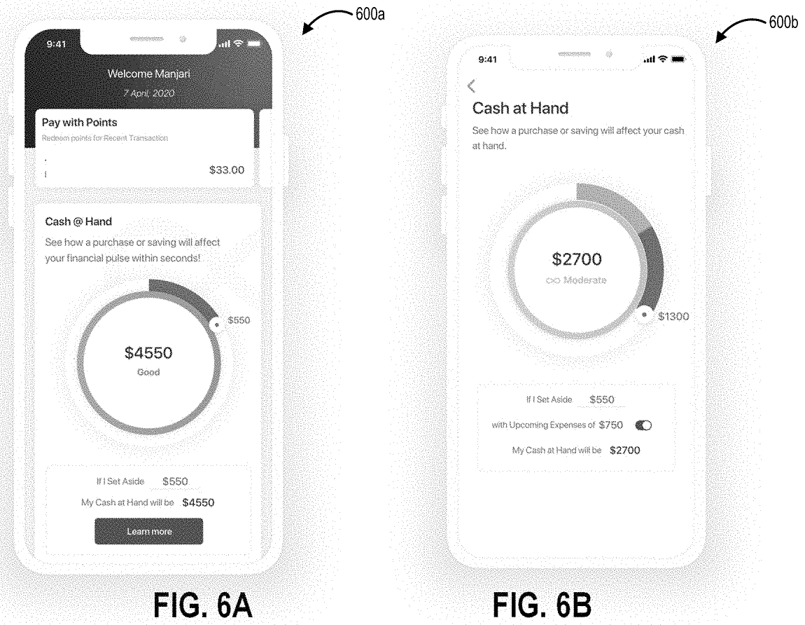

Reference is made to FIGS. 6A and 6B, which illustrate user interfaces (600a, 600b) for providing projected resource availability at a client device, in accordance with embodiments of the present disclosure. In FIGS. 6A and 6B, the user interfaces (600a, 600b) may include alternate graphical arrangements representing a targeted resource allocation. Further, the user interfaces (600a, 600b) include alternate graphical user interface elements for displaying projected resource availability associated with a user identifier.

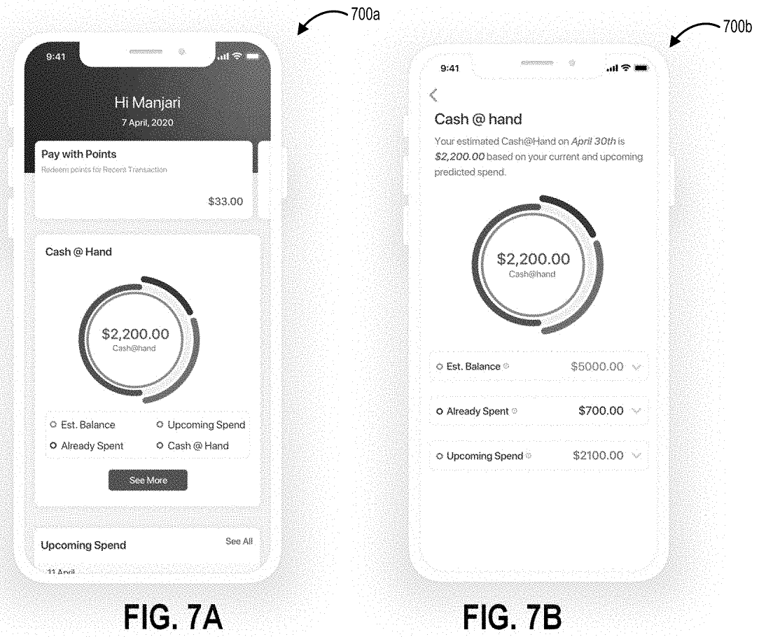

Reference is made to FIGS. 7A and 7B, which illustrate user interfaces (700a, 700b) for providing projected resource availability at a client device, in accordance with embodiments of the present disclosure. In FIGS. 7A and 7B, the user interfaces (700a, 700b) include alternate graphical user interface elements that graphically display granular details associated with the determined projected resource availability values. For example, the user interfaces (700a, 700b) may display quantity of resources that have already been allocated or transacted, or may display quantity of resources that are forecasted or scheduled to be allocated at some time in the future (e.g., upcoming spend).

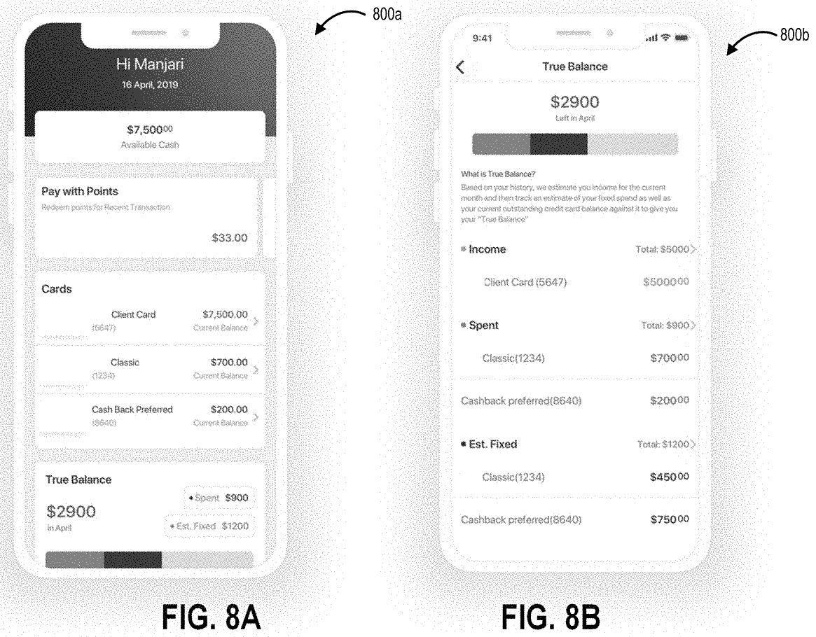

Reference is made to FIGS. 8A and 8B, which illustrate user interfaces (800a, 800b) for providing projected resource availability at a client device, in accordance with embodiments of the present disclosure. In FIGS. 8A and 8B, the user interfaces (800a, 800b) include alternate user interface elements displaying granular details associated with determined projected resource availability values. In some embodiments, the user interface elements may be provided along rectangular-shaped elements with color-coded features to display one or more categories of resource transactions. For instance, the rectangular-shaped elements may include income transactions, resource spending transactions, or estimated recurring or non-recurring resource transactions.

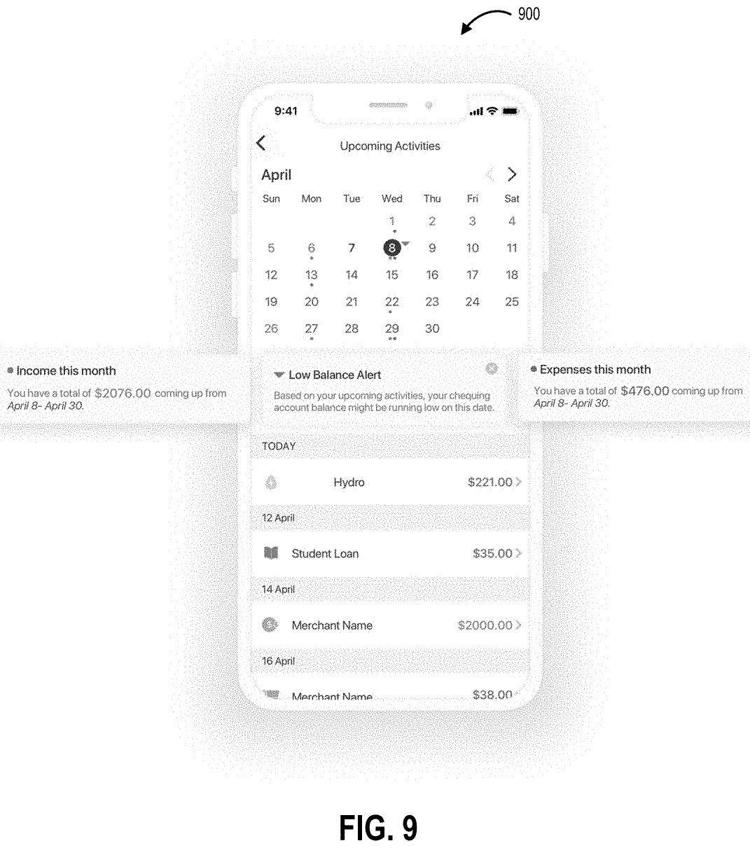

Reference is made to FIG. 9, which illustrates a user interface 900 for providing projected resource availability data messages, in accordance with embodiments of the present disclosure. The user interface 900 may include a calendar-type interface for identifying days of a month for projected recurring or non-recurring transactions.

In some embodiments, the user interface 900 may include text-based or non-text-based user interface elements for providing threshold alerts associated with projected resource availability. For example, the user interface 900 may include user interface elements for displaying a “Low Balance Alert” to a user of the client device, in response to determining that the projected resource availability may be below a threshold value on the basis of projected resource allocation transactions.

In some embodiments, the user interface 900 may include user interface elements for providing a summary of projected recurring or non-recurring resource allocations, such as projected income allocations (e.g., employee pay) or projected payment allocations (e.g., payment of expenses).

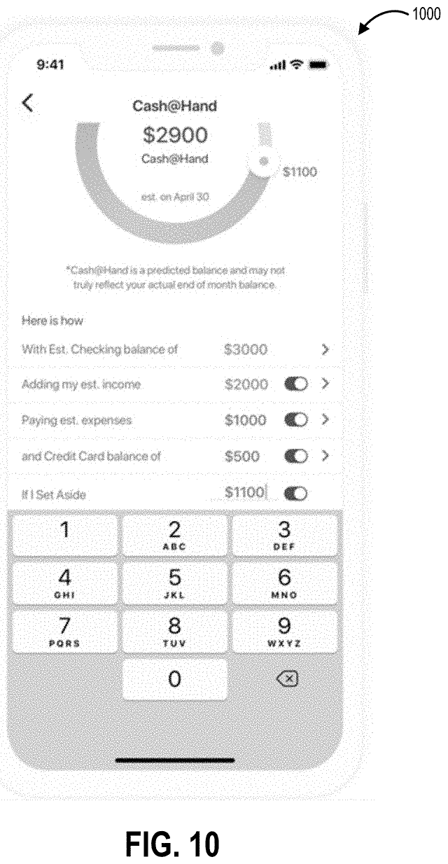

Reference is made to FIG. 10, which illustrates a user interface 1000, in accordance with another embodiment of the present disclosure.

In some embodiments, user interface elements for providing summaries of projected recurring or non-recurring allocations or for providing threshold alerts associated with projected resource availability can be provided by a resource pool application 112 (FIG. 1) or within an operating system or other graphical user interface provided on the client device 130 (FIG. 1). For example, an alert associated with an expected shortfall in a user's cash-flow or resources may be provided as a push notification banner on a client device (e.g., time-limited banner occurring on a login/lock screen or as a dynamic banner on a mobile device), as an email or short message system (SMS) message, or as another notification message that may be generated at an application other than the resource pool application 112. In some situations, alerts associated with projected resource availability may be provided when the user is both signed into/logged into or signed out of/logged out of the resource pool application 112.

As described in some examples of the present disclosure, Jane's resource pool may be based on an abundance of resource data sets associated with numerous networked resource processors (e.g., banking institution servers, other servers operated by numerous disparate vendors, etc.). In some situations, Jane may wish to expediently make decisions on whether to conduct resource allocation transactions (e.g., buy a product, set aside money in a retirement fund, etc.) but may require an indication of Jane's liquidity position as one factor in the decision making process. For example, Jane may be at a retail store contemplating a product purchase and may want to understand Jane's liquidity position as one factor in the decision making process.

In some situations, the value of the projected liquidity position may be increased when provided within a threshold period of time. It may be beneficial to provide systems of determining projected resource availability based on numerous features providing expedient or dynamic liquidity position feedback data.

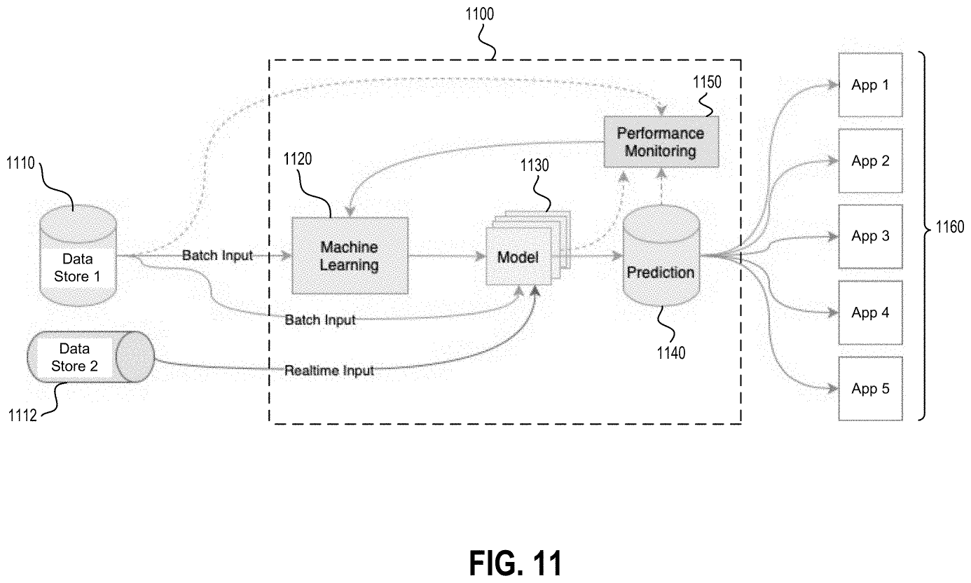

Reference is made to FIG. 11, which illustrates an architecture diagram of a platform including a resource prediction system 1100, in accordance with embodiments of the present disclosure. The system 1100 may be configured to generate projected resource availability values (e.g., Cash@Hand indicators) based on large data sets obtained from a plurality of disparately located data source devices. As described herein, it may be beneficial to generate such projected resource availability indications on an expedient or substantially real-time basis. The system 1100 may including features for providing such dynamic resource availability indicators within time threshold values, or other performance metrics.

The system 1100 may transmit messages to or may receive messages from a plurality of computing devices via one or more communication networks. The computing devices may include data source devices, such as a first data store 1110 or a second data store 1112.

The computing devices may also include one or more client devices 1160 having user interface applications executed thereon. In FIG. 11, the system 1100 is illustrated as transmitting messages to/receiving messages from one of five client devices 1160; however, the system 1100 may communicate with any number of client devices 1160. In some embodiments, one or more of the five illustrated client devices 1160 may be configured with operations for providing user interfaces for displaying resource availability indicators, for example as illustrated in FIG. 2 or FIG. 4. Other types of applications or user interfaces may be provided at the respective client devices 1160.

In some embodiments, the first data store 1110 may be a data storage device storing comprehensive or historical data sets associated with resource allocation transactions associated with a plurality of banking customer users. The first data store 1110 may include large data sets that may be processed and may be batch stored or batch transmitted to other systems for downstream computing operations. In some embodiments, data sets stored or transmitted in batches may represent resource transaction data as current as the latest date/time stamp associated with the data sets.

In some embodiments, the second data store 1112 may be associated with a data storage device for aggregating a plurality of data records as the data records on a substantially real-time basis.

The first data store 1110 may store data sets representing resource transfer transactions up until 11:59 pm on a daily basis. In contrast, the second data store 1112 may a data storage system for aggregating data records on a substantially real-time basis, such that “fresh” or real-time data may be available for systems conducting operations described herein.

To illustrate, a batch data set may include data records for determining Jane's liquidity position as of 11:59 pm of the previous day (e.g., day 1). On day 2, if Jane visits a store to conduct a large purchase (e.g., resource transfer transaction) at 9 am, systems that may rely predominately on batched data sets from the first data store 1110 may be unable to provide an indication of Jane's liquidity position accurate to 9:01 am on day 2. Thus, in some embodiments, the second data store 1112 may provide data sets for generating liquidity positions based on data sets having greater time granularity.

In some embodiments, the system 1100 of FIG. 11 may be an example of the system illustrated in FIG. 1. The system 1100 may be configured with memory storing processor-executable instructions that, when executed, configure the processor to conduct machine learning operations 1120. In some embodiments, the machine learning operations 1120 may represent training and generation of machine learning models.

Upon completion of the generating and training of machine learning models 1120, the system 1100 may propagate the trained machine learning models as stored models 1130. In some embodiments, it may be beneficial for the system 1100 to separate or decouple operations for: (i) generating and training machine learning models (e.g., machine learning operations 1120); and (ii) execution of machine learning models (e.g., stored models 1130). Decoupling the generation/training from the execution of machine learning models may ameliorate delays associated with operations for generating predictions that otherwise would occur.

In examples where the generating/training of machine learning models is not decoupled from stored models for execution, retraining and maintenance operations of machine learning models may result in model execution operations (e.g., for prediction) to be temporarily queued or halted. Accordingly, decoupling the generating/training of machine learning models from executing operations of the machine learning models may allow the system 1100 to be configured to provide more timely prediction 1140 within desirable time threshold value (e.g., within 3 seconds of a trigger event) than otherwise would be possible.

In some embodiments, upon successful generation and training of machine learning models 1120, the system 1100 may propagate machine learning models as stored models 1130. In some embodiments, a model may be identified as generated and trained based on model performance metrics that are met (e.g., model accuracy based on validation training sets).

The system 1100 may be configured to conduct performance monitoring operations 1150. Performance monitoring thresholds may include time-based threshold values that define how expediently operations of the system 1100 may be expected to provide predictions 1140 to client devices 1160. For example, a time-based threshold value may be three seconds, and the system 1100 may be evaluated on the system ability to provide a resource availability prediction within 3 seconds of receiving a signal representing a user's targeted resource allocation (e.g., a user activating the user interface element 224 of FIG. 2 or FIG. 4). Other performance monitoring threshold types may be used.

In situations where the performance monitoring operations 1150 determine that the system 1100 may not be providing predictions 1140 within configured performance metrics/standards (e.g., time-to-prediction metric, etc.), the system 1100 may be configured to identify one or more machine learning models 1120 being generated/trained but not yet propagated as a stored model 1130. In the present example, the system 1100 may identify one or more generated/trained machine learning models for propagation with a view to improving performance metrics/standards of the overall system.

In some embodiments, propagating generated/trained machine learning models 1120 as stored models 1130 may include operations for augmenting previously stored models 1130. In some embodiments, the system 1100 may conduct operations for augmenting model parameters with weights with a view to improving performance metrics/standards of the overall system.

In some embodiments, the performance monitoring operations 1150 may include operations for testing prior-stored models 1130 with validation data sets, with a view to determining whether the prior-propagated or prior-stored models 1130 may be suitable for providing predictions 1140. As an example, one or more of the client devices 1160 may be configured with a Cash@Hand application having a user interface shown in FIG. 4. In another example, one or more of the client devices 1160 may include calendar applications having a user interface shown in FIG. 9 for displaying resource availability predictions. In other examples, the one or more client devices 1160 may have other applications (e.g., loyalty management applications, online banking applications) including user interfaces for displaying prediction values. Thus, in some situations, the performance monitoring operations 1150 may include operations for dynamically or continuously monitoring whether prior-propagated or prior-stored models 1130 are configured to provide predictions to the respective client devices applications based on established performance metrics.

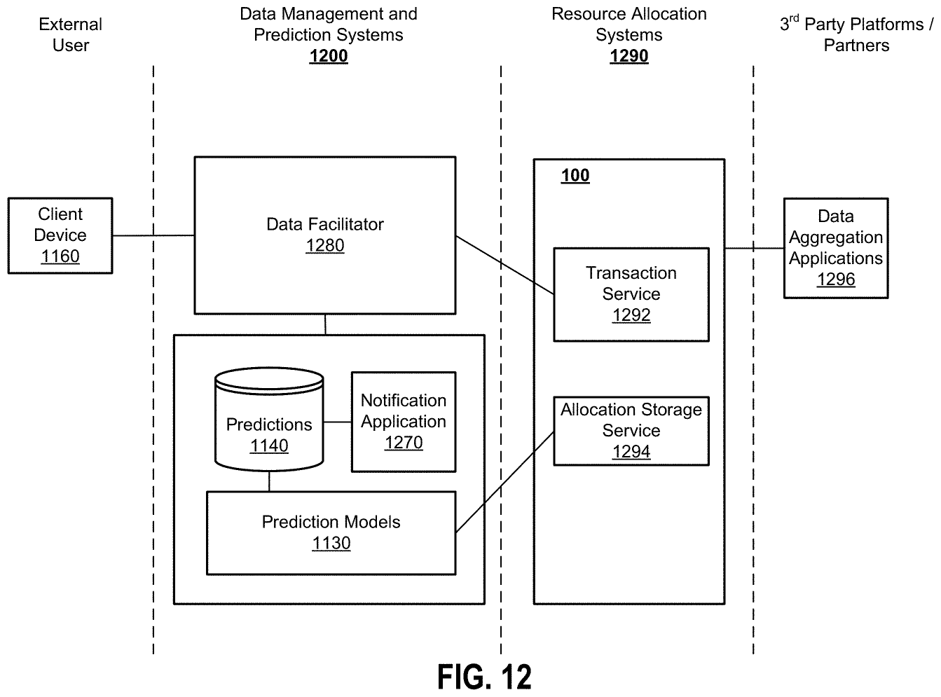

Reference is made to FIG. 12, which illustrates a block diagram of a platform including the resource prediction system 1200, in accordance with embodiments of the present disclosure.

In FIG. 12, one or more client devices 1160 may be in communication with the resource prediction system 1200. Further, the resource prediction system may be in communication with resource allocation systems 1290.

In some embodiments, resource allocation systems 1290 may include computing devices configured to aggregate or combine data sets associated with a plurality of users. The data sets may represent resource allocation transactions among one or more of the plurality of users, among other examples of data sets.

In some embodiments, the resource allocation systems 1290 may include a transaction service 1292 including operations for generating data sets on a substantially real-time basis. For example, the transaction service 1292 may include operations for storing resource allocation data associated with day-to-day banking customers.

In some embodiments, the transaction service 1292 may be configured to retrieve resource allocation data from data aggregation applications 1296, where the data aggregation applications 1296 may be configured by third parties or partners. As an example, the data aggregation applications 1296 may include Yodlee™ or other similar data aggregation services. By retrieving resource allocation data from data aggregation applications 1296, the resource allocation systems 1290 may generate comprehensive data sets associated with respective banking customer users originating from a plurality of data sources (e.g., combination of resource transfer data sets from within a banking institution, and from other entities, such as other banking institutions, or the like, that may generate resource transfer data sets).

In some embodiments, the allocation storage service 1294 may include operations for storing comprehensive historical data sets associated with resource allocation transactions over time. In some embodiments, the allocation storage service 1294 may include operations for generating batch data sets to be batch stored or batch transmitted to other systems for downstream computing operations. For example, the batch stored data sets may be propagated as training data sets for generating and training machine learning models 1120 (FIG. 11). In another example, the batch stored data sets may be propagated as inputs to stored models 1130 (FIG. 11) for providing predictions 1140. In some embodiments, the transaction storage service 1294 may represent an authoritative source for prior-conducted resource allocation data. The prior-conducted resource allocation data may represent past recurring resource allocations (e.g., monthly subscription payments, bi-weekly payroll payments) or past non-recurring resource allocations (e.g., ad hoc purchases at retail stores, etc.).

In some embodiments, the stored prediction models 1130 may be based on operations of Pandas UDF within the Apache Spark™ framework.

In some embodiments, on a periodic basis, the resource allocation systems 1290 may be configured propagate data sets generated by the transaction service 1292 for storage by the allocation storage service 1294.

The resource prediction system 1200 of FIG. 12 may be an example of the resource prediction system 1100 illustrated in FIG. 11. The resource prediction system 1200 of FIG. 12 may include a data facilitator application 1280 for retrieving data sets from the transaction service 1292 described herein. Further, the data facilitator application 1280 may be configured to retrieve and transmit prediction output from machine learning models to the client devices 1160.

The resource prediction system 1200 may include prior-stored models 1130, which may include operations of a prediction application for generating predictions. The prior-stored models 1130 may retrieve data sets representing recurring and non-recurring resource allocations. Further, the prior-stored models 1130 may retrieve data sets that may be based on batch stored (e.g., from the allocation storage service 1294 or may be based on substantially real-time data (e.g., from the transaction service 1292).

In some embodiments, the prior-stored models 1130 may be implemented based on operations of an Apache Spark™ data analytics operations for large-scale data processing. In some embodiments, prediction outputs may be pre-emptively generated by the prior-stored models 1130 on a periodic basis. In some embodiments, prediction outputs may be generated on an on-demand basis. The generated prediction outputs may be stored or served to a data store of predictions 1140. In some embodiments, the data store of predictions 1140 may include operations of an SQL™ server.

In some embodiments, the resource prediction system 1200 may include a notification application 1270 including operations for generating notifications based on predicted resource availability outputs. For example, the notification application 1270 may include operations for identifying when resource availability for banking customer users meets a “low balance” threshold and, subsequently, generating notifications for propagating to downstream operations. In another example, the notification application 1270 may include operations for generating resource availability projections for future time periods (e.g., next week, next month) for banking customer users. Other operations of the notification application 1270 may be contemplated for generating outputs for display as one or more user interfaces on client devices 1160.

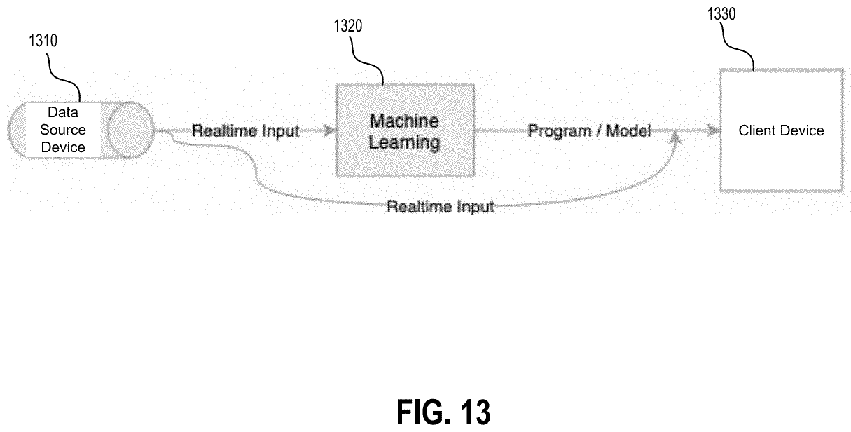

Reference is made to FIG. 13, which illustrates an architecture diagram of a platform including a system 1320 for generating projected resource availability values (e.g., Cash@Hand indicators, among other examples) based on on-demand queries of data sets, in accordance with embodiments of the present disclosure.

The system 1320 may transmit messages to or may receive messages from a plurality of computing devices via one or more communication networks. For example, the computing devices may include one or more data source devices 1310 and one or more client devices 1330.

In some embodiments, the one or more data source devices 1310 may include data sources associated with third party data aggregators (e.g., Yodlee™), data sources associated with personal client transactions or accounts, data sources associated with business account or transactional data, among other examples.

An example of a banking customer associated with a client device 1330 configured with an application providing a “Cash©Hand” user interface (e.g., FIG. 2 and FIG. 4) will be described to illustrate embodiments of the present disclosure.

The system 1320 may be configured to receive a signal associated with a targeted resource allocation and a user identifier from a client device 1330. The user identifier may be a unique username, pseudo identifier, or the like associated with a banking customer. The targeted resource allocation may represent a user's proposal to conduct a resource allocation (e.g., imminent purchase of a product or service, plan to set aside money within an investment account, etc.).

In the present example, the signal associated with the targeted resource allocation may provide a basis for determining a projected resource availability in the event that a user associated with the targeted resource allocation results in execution of a data process to allocate that targeted resource allocation (e.g., confirming a product purchase).

In some situations, the value of the projected resource availability indication (e.g., liquidity position of the identified user) may be increased if the projection is based on substantially up-to-date data sets, the system 1320 may be configured to execute machine learning models based on data sets retrieved on-demand from the one or more data source devices 1310. By retrieving data sets on a substantially on-demand basis, the system 1320 may conduct downstream operations to generate projected resource availability based on non-stale/up-to-date data sets represent recurring or non-recurring resource transfers.

As an example, in situations where the systems for generating projected resource availability may be based on batched data sets that may be bundled on a daily basis (e.g., at 11:59 pm each evening), projected resource availability generated based on such batched data sets may provide a relatively stale projected resource availability indication in the event that a user conducts a resource allocation in the morning following the batched data set 11:59 pm time stamp of a prior day. Accordingly, embodiments of the system 1320 may be configured to retrieve data sets on a substantially on-demand basis from the one or more data source devices 1310.

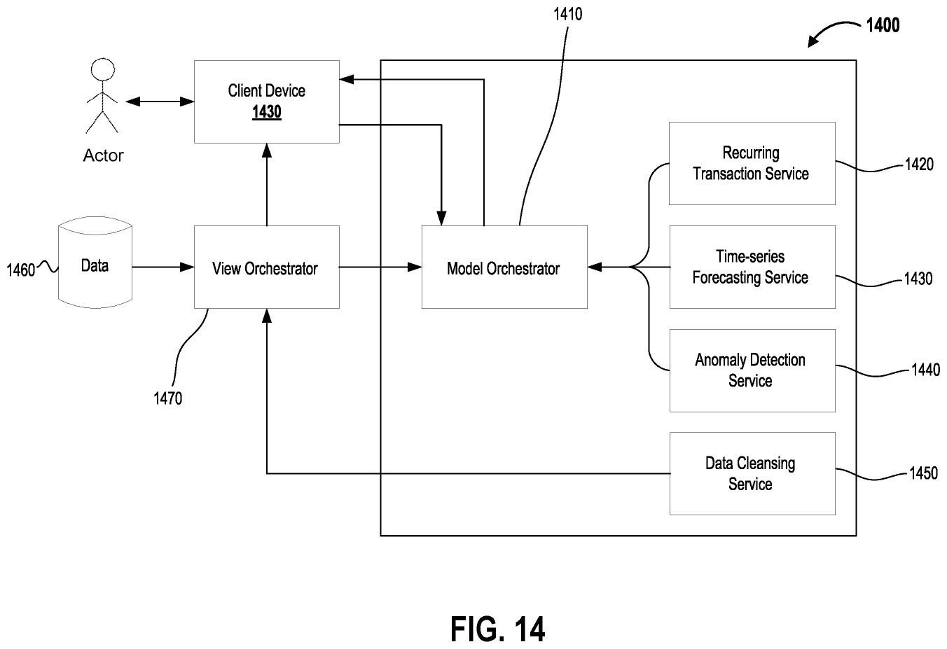

Reference is made to FIG. 14, which illustrates a block diagram of a resource allocation system 1400, in accordance with embodiments of the present disclosure. The resource allocation system 1400 may be included or implemented by operations of the resource pool application 112 or other applications not illustrated in FIG. 1. In some embodiments, the resource allocation system 1400 may include features of the system 1320 described with reference to FIG. 13.

The resource allocation system 1400 may include a model orchestrator 1410. The model orchestrator 1410 may be configured as an circuit interface for communicating data messages between the client device 1430 and other sub-systems of the resource allocation system 1400.

In some embodiments, the model orchestrator 1410 may include operations for transmitting data to or receiving data from the one or more data source devices 1460. For example, the one or more data source devices may include data sources associated with third party data aggregators (e.g., Yodlee), data sources associated with personal client transactions and accounts, data sources associated with business account and transactional data, etc. In some embodiments, transmitted data or received data may be organized, re-formatted, or transformed into data sets via operations of a view orchestrator 1470.

The model orchestrator 1410 may include operations for interfacing with a recurring transaction service 1420, a time-series forecasting service 1430, and/or an anomaly detection service 1440. In some embodiments, the model orchestrator 1410 may generate parameters based on data messages received from the client device 1430. For example, parameters may be associated with rules associated recurring transaction, resource allocation categories, account type categories, among other rules-based parameters.

The model orchestrator 1410 may include operations for receiving signals associated with a prospective resource allocation, such that subsequent sub-systems of the resource allocation system 1400 may conduct operations to determine resource availability projections.

In some embodiments, the model orchestrator 1410 may include operations to disregard resource allocation or transaction data after particular date stamps. In some embodiments, the model orchestrator 1410 may include operations to map resource allocation data to particular data records based on associated user identifiers. In some embodiments, the model orchestrator 1410 may include operations to pre-filter resource allocation operations having transaction values greater than threshold values. Other operations for pre-filtering resource allocation operations may be contemplated.

To illustrate an embodiment of the model orchestrator 1410, Table 1 (below) outlines definitions of an example data structure that may be associated with an input request for operations of the model orchestrator 1410.

TABLE 1
Example data structure definitions

| Element | Data Type | Description | Mandatory | Example |
|---|---|---|---|---|
| appId | String | Application key for | Yes | ″wallet″ |
| | | configurations and | | |
| | | data source in the | | |
| | | Orchestrator | | |
| userId | String | Unique id of the | Yes | ″4519033065457324″ |
| | | user. For users, it is | | |
| | | the client card | | |
| | | number | | |
| predictionTypes | Array | This element | Yes | [″RECURRING″, |
| | | specifies the types of | | ″NON_RECURRING″, |
| | | predictions to be | | ″BALANCE″, |
| | | performed for the | | ″ANOMALIES″, |
| | | user. notes\ | | ″NEW_MERCHANT″] |
| | | calling for balance | | |
| | | will trigger recurring | | |
| | | and non recurring | | |
| | | calls. \balance | | |
| | | cannot be called with | | |
| | | categoriesOverride\ | | |
| | | only anomalies | | |
| | | from 60 days prior | | |
| | | to the cutoffDate | | |
| | | will be returned | | |
| cutoffDate | Date | Predict From date. | No | 2019-03-15 |
| | | Default: Today's | | |
| | | system date | | |
| predictCutoff | Date | Predict To Date. | No | 2019-04-30 |
| | | Default: Last day of | | |
| | | the month of | | |
| | | (cutoffDate + 1 | | |
| | | month) | | |
| filters | Array[Filter] | This list of | No | Sample Request |
| | | filters to | | ] |
| | | apply to the | | { |
| | | transaction list | | ″name″: |
| | | | | ″CATEGORY″, |
| | | | | ″value″: |
| | | | | ″string″ |
| | | | | } , { |
| | | | | ″name″: |
| | | | | ″MERCHANT_NAME″, |
| | | | | ″value″: |
| | | | | ″string″ |
| | | | | } , { |
| | | | | ″name″: |
| | | | | ″SUBTYPE″, |
| | | | | ″value″: |
| | | | | ″string″ |
| | | | | } , { |
| | | | | ″name″: |
| | | | | ″CATEGORY_TYPE″, |
| | | | | ″value″: |
| | | | | ″string″ |
| | | | | } |
| | | | | ] |
| skipCache | Boolean | If true, skip the redis | No | false |
| | | cache for fetching | | |
| | | accounts and | | |
| | | transactions | | |
| | | Default: false | | |
| requesterinfo | RequesterInfo | Used for | Yes | Sample Request |
| | | internal auditing | | { |
| | | | | ″lang″: ″string″, |
| | | | | ″app″: ″string″, |
| | | | | ″version″: |
| | | | | ″string″, |
| | | | | ″mobileDeviceInfo″: |
| | | | | { |
| | | | | ″deviceModel″: |
| | | | | ″string″, |
| | | | | ″deviceOSVersion″: |
| | | | | ″string″, |
| | | | | ″devicePlatform″: |
| | | | | ″string″ |
| | | | | } } |

Table 2 illustrates an input request associated with operations of the model orchestrator 1410 and an example output associated with operations of the model orchestrator 1410.

TABLE 2
A representative portion of example input and output
associated with operations of the model orchestrator 1410

| Sample Request | Sample Response |
|---|---|
| { | { |
| “appId”: “string”, | “accountId”: 33032328, |
| “cutoffDate”: “2017-06-03”, | “accountType”: “CHECKING”, |
| “predictCutoff”: “2017-07-03”, | “container”: null, |
| “predictionTypes”: [ | “currencyType”: “CAD”, |
| “RECURRING”, | “recurringPredictions”: [ |
| “NON_RECURRING”, | { |
| “BALANCE” | “amount”: 10, |
| ], | “baseType”: “DEBIT”, |
| “requesterInfo”: { | “category”: 2, |
| “lang”: “string”, | “categoryType”: “EXPENSE”, |
| “app”: “string”, | “date”: “2017-06-26”, |
| “version”: “string”, | “description”: “Auto Loan”, |
| “mobileDeviceInfo”: { | “subType”: “AUTO_LOAN” |
| “deviceModel”: “string”, | }, |
| “deviceOSVersion”: | { |
| “string”, | “amount”: 108.57, |
| “devicePlatform”: “string” | “baseType”: “DEBIT”, |
| } | “category”: 6, |
| }, | “categoryType”: “EXPENSE”, |
| “skipCache”: false, | “date”: “2017-06-26”, |
| “userId”: “4519033065457324” | “description”: “Union Gas |
| ] | Limited”, |
| | “merchantName”: “Union Gas |
| | Limited”, |
| | “subType”: |
| | “UTILITIES_PAYMENT” |
| | }, |
| | ... |
| | “nonRecurringPredictions”: [ |
| | { |
| | “baseType”: “CREDIT”, |
| | “categoryType”: “INCOME”, |
| | “predictions”: [ |
| | { |
| | “ds”: “2017-06-03”, |
| | “y”: 1792 |
| | }, |
| | { |
| | ] |
| | }, |
| | ... |
| | “balancePredictions”: [ |
| | { |
| | “ds”: “2017-06-03”, |
| | “y”: 608 |
| | }, |
| | { |
| | “ds”: “2017-06-10”, |
| | “y”: 2809 |
| | }, |
| | ... |
| | ], |
| | “anomalies”: [ |
| | { |
| | “amount”: 4300, |
| | “baseType”: “DEBIT”, |
| | “category”: 11, |
| | “currrencyType”: “CAD”, |
| | “date”: “2017-04-10”, |
| | “description”: “Transfer”, |
| | “subType”: “TRANSFER” |
| | }, |
| | ], |
| | ... |

Table 3 (below) outlines definitions of the sample response depicted above.

TABLE 3
Example data definitions

| Attribute Name | | Description |
|---|---|---|
| accountId | | The account from which the |
| | | transaction was made. This is |
| | | basically the primary key of the |
| | | account resource. |
| accountType | | The type of account that is |
| | | aggregated, i.e., checking, credit |
| | | card. The account type is derived |
| | | based on the attributes of the |
| | | account. |
| container | | The account's container. Either |
| | | bank or creditCard |
| currencyType | | Account Currency on which all |
| | | amounts will be based on |
| recurringPredictions | | |
| | amount | The forecasted amount of the |
| | | transaction |
| | baseType | Indicates if the transaction appears |
| | | as a debit or a credit transaction in |
| | | the account. |
| | category | Category ID reference |
| | categoryType | The categoryType of the category |
| | | assigned to the transaction. |
| | | EXPENSE, INCOME |
| | currrencyType | Transaction original currency |
| | date | Transaction forecasted date |
| | description | The transaction description that |
| | | appears at the Fl site may not be |
| | | self-explanatory, i.e., the source, |
| | | purpose of the transaction may not |
| | | be evident. Yodlee attempts to |
| | | simplify and make the transaction |
| | | meaningful to the consumer, and |
| | | this simplified transaction |
| | | description is provided in the simple |
| | | description field. |
| | frequency | recurrance frequency |
| | | (weekly, biweekly, or monthly) |
| | merchantName | The name of the merchant |
| | | associated with the transaction. |
| | subType | The transaction subtype field |
| | | provides a detailed transaction |
| | | type. For example, purchase is a |
| | | transaction type and the transaction |
| | | subtype field indicates if the |
| | | purchase was made using a debit |
| | | or credit card. |
| nonRecurring- | | |
| Predictions | | |
| | baseType | Indicates if the transaction appears |
| | | as a debit or a credit transaction in |
| | | the account. |
| | categoryType | The categoryType of the category |
| | | assigned to the transaction. |
| | | EXPENSE, INCOME |
| | ds | Forecasted Date |
| | y | Forecasted amount |
| balancePredictions | | |
| | ds | Forecasted date |
| | y | Forecasted balance amount. For |
| | | credit card, this is the available |
| | | balance remaining |
| | alert | Indicates whether the checking |
| | | account balance or creditCard |
| | | account balance available amounts |
| | | below or equal to pre-set |
| | | configuration threshold |

In some embodiments, the recurring transaction service 1420 may receive pre-filtered data sets. In some examples, pre-filtered data sets may include data sets having incomplete data entries removed from the set. In some examples, data entries may have been categorized or grouped according to common characteristics, or the like. In some embodiments, the view orchestrator 1470 may be configured to pre-filter data sets received from the one or more data sources 1460.

In some embodiments, operations for pre-filtering data sets may include extracting or simplifying merchant names associated with resource allocation data. In some embodiments, operations for pre-filtering data sets may include categorizing resource allocation data to reduce unexpected predictions. For example, purchases at a gas station may be categorized as “automotive purchase” (e.g., likely a non-recurring transaction) as opposed to “recreation” (e.g., in some scenarios a recurring transaction). Other operations for pre-filtering data sets for subsequent recurring transaction forecasting may be contemplated.

The recurring transaction service 1420 may include processor-readable instructions that configure a processor to: (1) identify recurring transactions or recurring allocations based on data sets representing past transactions; and (2) forecast recurring transactions that may be conducted at a future point in time.

In some embodiments, the recurring transaction service may be configured to conduct rules based operations to identify recurring resource allocations based on pre-defined set of rules, including data or amount ranges. Example recurring transactions may include resource allocations occurring on a periodic basis (e.g., paying a monthly subscription service fee). In another example, recurring resource allocations may include recurring transfers (e.g., pre-authorized payment) of money to a service provider (e.g., telephone service provider, video-streaming service provider) as a monthly subscription or service fee. In some embodiments, a processor may identify recurring transactions based on pre-processed data sets of user transaction and bank account data entries.

In some situations, periodic or recurring resource allocations may not occur on exact time intervals. For example, a resource allocation system may be configured to conduct operations to allocate resources on a normal operating business day (e.g., Monday to Friday). In situations where periodic resource allocations may be configured for a particular day (e.g., 1st day of a month) and the particular day may not be on a normal operating business day, the resource allocation may occur on a next day that is a normal operating business day. Accordingly, in some embodiments, the recurring transaction service 320 may include operations based on parameters that account for variances in frequency metrics, such as weekly, bi-weekly, monthly, yearly, etc.

For example, the recurring transaction service 1420 may include operations having parameters denoting a date deviation in days from a last observed transaction (“day ranges”), a number of qualifying recurrences (“number of recurrences”), or amount deviation as a percentage value (“txAmountRange”). Other parameters associated with rules-based operations for determining identifying recurring transactions in past time periods may be contemplated.

The following tables provide example pseudocode illustrating operations of the recurring transaction service 1420, in accordance with embodiments of the present application. Table 4 illustrates example pseudocode for identifying monthly recurring transactions or resource allocations.

TABLE 4
Identifying Monthly Recurring Transactions or Resource Allocations

| Weekly Recurring | Weekly Recurring (gap or outlier) |
|---|---|
| JOIN past 7 day transactions (forecast | JOIN past 7 day transactions (forecast from |
| from date — 7 days (inclusive)) | date — 7 days (inclusive)) |
| WITH transactions found in the past n | WITH transactions found in the past n |
| recurringInstance weeks. This per observed | recurringInstance weeks. This per observed |
| transaction date and +− a ‘fuzzy’ day ranges | transaction date and +− a ‘fuzzy’ day ranges |
| per week | per week |
| ON accountId, currencyType, baseType, | ON accountId, |
| (merchantName (if provided) else | currencyType, baseType, (merchantName (if |
| description), category, sub Type, | provided) else description), category, subType, |
| AND amount within ‘wiggle’ range | |
| If n recurringInstance transactions match, | If n-1 recurringInstance transactions match in |
| label Recurring Weekly, and exclude from | addition on amount within ‘wiggle’ range, |
| dataset | label Recurring Weekly, and exclude all list |
| | transactions from dataset |
| note if multiple transactions matched, | note if multiple transactions matched, choose |
| choose closest in date else first transaction | closest in date else first transaction with the |
| with the least amount variance | least amount variance |

In another example, Table 5 illustrates pseudocode for identifying bi-weekly recurring transactions or resource allocations.

TABLE 5
Identifying Bi-Weekly Recurring Transactions or Resource Allocations

| Bi-Weekly Recurring | Bi-Weekly Recurring (gap or outlier) |
|---|---|
| JOIN past 14 day transactions (forecast from | JOIN past 14 day transactions (forecast from |
| date — 14 days (inclusive)) | date— 14 days (inclusive) |
| WITH transactions found in the past n | WITH transactions found in the past n |
| recurringInstance bi-weeks. This per | recurringInstance bi-weeks. This per |
| observed transaction date and +− a ‘fuzzy’ | observed transaction date and +− a ‘fuzzy’ day |
| day ranges per bi-week | ranges per bi-week |
| ON accountId, | ON accountId, currencyType, baseType, |
| currencyType, baseType,(merchantName (if | (merchantName (if provided) |
| provided) else description), category, subType, | else description), category, subType |
| AND amount within ‘wiggle’ range | |
| If n recurringInstance transactions match, | If n-1 recurringInstance transactions match in |
| label Recurring Bi-Weekly, and exclude from | addition on amount within ‘wiggle’ range, |
| dataset | label Recurring Bi-Weekly, and exclude all |
| | list transactions from dataset |
| note if multiple transactions matched, choose | note if multiple transactions matched, choose |
| closest in date else first transaction with the | closest in date else first transaction with the |
| least amount variance | least amount variance |

In another example, Table 6 illustrates pseudocode for identifying monthly recurring transactions or resource allocations.

TABLE 6
Identifying Monthly Recurring Transactions or Resource Allocations

| Monthly Recurring | Monthly Recurring (gap or outlier) |
|---|---|
| JOIN past 1 month transactions (forecast | JOIN past 1 month transactions (forecast |
| from date — 1 month (inclusive)) | from date — 1 month (inclusive)) |
| WITH transactions found in the past n | WITH transactions found in the past n |
| recurringInstance months. This per | recurringInstance months. This per observed |
| observed transaction date and +− a ‘fuzzy’ | transaction date and +− ‘fuzzy’ day ranges |
| day ranges per month | per month |
| ON accountId, currencyType, | ON accountId, currencyType, baseType, |
| baseType, (merchantName (if provided) else description), | (merchantName (if provided) |
| category, subType, | else description), category, subType |
| AND amount within ‘wiggle’ range | |
| If n recurringInstance transactions match, | If n-1 recurringInstance transactions match in |
| label Recurring Monthly, and exclude from | addition on amount within ‘wiggle’ range, |
| dataset | label Recurring Monthly, and exclude all list |
| | transactions from dataset |
| note if multiple transactions matched, | note if multiple transactions matched, choose |
| choose closest in date else first transaction | closest in date else first transaction with the |
| least amount variance | with the least amount variance |

In some embodiments, the recurring transaction service 1420 may include operations for forecasting recurring transactions up to a future point-in-time. For example, operations may predict recurring resource allocations occurring a week from today, a month from today, etc., based on identified recurring resource allocations of the past. For example, the recurring transaction service 1420 may be configured to identify or estimate future subscription or service fees based on past subscription or service fee payments.

In some embodiments, the recurring transaction service 1420 may include operations for forecasting recurring resource allocations based on a median value of a threshold number of pf prior recurring transactions. Other operations for forecasting recurring resource allocations may be contemplated.

As described, the resource allocation system 1400 may include a time-series forecasting service 1430. In some embodiments, the time-series forecasting service 1430 may include operations to predict or forecast future resource allocations or resource transactions associated with a user identifier.

In some embodiments, the time-series forecasting service 1430 may be configured to generate predicted resource allocations based on prior time-series data associated with resource allocations associated with a user identifier. For example, the time-series forecasting service 1430 may forecast the user's projected spend at a particular restaurant establishment (e.g., coffee shop) based on one or more data entries of time-series data from the data sources 1460. The forecasted spend at the particular restaurant establishment may be based on past frequency of the user's spending at that particular restaurant establishment, on calendar entries that may identify that particular restaurant establishment for a meeting, etc.

In some embodiments, the time-series forecasting service 1430 may conduct operations to predict resource allocations based on prior time-series data associated with a particular user identifier, to the exclusion of prior time-series data associated with other user identifiers. As the usefulness of projected liquidity position may increase when provided within a threshold period of time (e.g., within three seconds of receiving user input associated with a prospective resource transaction), predicting resource allocations on a user-by-user basis may be more expedient than predicting resource allocations based on predictive analysis of batched data across a plurality of users.

In some embodiments, the time-series forecasting service 1430 may conduct modelling operations based on one or more models for determining resource availability projections. For example, the time-series forecasting service 1430 may include operations of forecasting resource allocations based on an additive model where non-linear trends may be fitted with yearly, weekly, or daily seasonality, plus holiday effects. In some scenarios, such curve-fitting modelling operations may be known as “Prophet” modeling operations.

In some embodiments, the time-series forecasting service 1430 may include operations for exponential smoothing using exponential window functions. In some embodiments, the time-series forecasting service 1430 may include operations based on transformation and regression operations, such as a TBATS model. In some embodiments, the time-series forecasting service 1430 may include operations of an autoregressive integrated moving average (ARIMA) model. In some embodiments, the time-series forecasting service 1430 may include operations of an AUTO ARIMA model. In some embodiments, the time-series forecasting service 1430 may include operations of an exponential smoothing (ETS) model. In some embodiments, the time-series forecasting service 330 may conduct operations to incorporate trending or seasonality data.

In some embodiments, the time-series forecasting service 1430 may require resource data set portions received from the data source devices 1460 from at least a set duration of time in the past (e.g., earliest resource transaction being 30 days prior for daily forecasting or 4 weeks for weekly forecasting). In some embodiments, the time-series forecasting service 1430 may conduct operations to for detecting outliers based on interquartile range calculations.

In some embodiments, the time-series forecasting service 1430 may conduct operations of runtime evaluation of multiple algorithms, thereby electing an optimal score for prediction operations.

To illustrate an embodiment of the time-series forecasting service 1430, Table 10 (below) outlines definitions of an example data structure that may be received as an input request for operations of the time-series forecasting service 1430.

TABLE 10
Example data structure definitions for input request
to time-series forecasting operations

| Element | Description | Example |
|---|---|---|
| account_id | Single valued, String | ″65457324″ |
| forecastFromDate | Date to forecast from, date, Default | ″2019-05-05″ |
| | today's date | |
| frequency | Prediction frequency, (″daily″ or | ″weekly″ |
| | ″weekly″), String, Default ″weekly″ | |
| predictSteps | Number of steps to predict into the | 4 |
| | future, Integer, Default 4 | |
| outlierMultiplier | Interquartile multiplier value for range | 3 |
| | limits are the typical upper and lower | |
| | whiskers of a box plot. Integer Default 1 | |
| error_type | Scoring metrics. | ″RMSE″ |
| | (″RMSE″, ″MAPE″, ″MAE″), | |
| | String, Default ″RMSE″ | |
| algorithms | Which algorithm(s) to be run. (″arima″, | [″auto_arima″, |
| | ″auto_arima″, ″ets″, ″tbats″, ″prophet″), | ″ets″] |
| | a List of String, Default [″ets″]′. | |
| transactions | | |
| -ds | Transaction Data Stamp, Date | ″2019-02-28″ |
| -y | Transaction value, Integer | ″100″ |
| -cat | Sub Category of the transaction | ″Groceries″ |

Table 11 illustrates an example input request associated with operations of the time-series forecasting service 1430 and an example output associated with operations of the time-series forecasting service 1430.

TABLE 11
Example time-series data input and output associated
with operations of the time-series forecasting service 1430

| Sample Request | Sample Response |
|---|---|
| { | { |
| “account_id”: “6947737”, | “Forecast”: [ |
| “forecastFromDate”: “2020-02-01”, | { |
| “frequency”: “weekly”, | “ds”: “2020-02-07”, |
| “predictSteps”: 2, | “y”: 1130.0 |
| “outlier_multiplier”: 1, | }, |
| “error_type”: “rmse”, | { |
| “algorithms”: [“ets”], | “ds”: “2020-02-14”, |
| “transactions”: [ | “y”: 900.0 |
| { | } |
| “ds”: “2020-01-03”, | ], |
| “y”: 1130 | “Val Accuracy Level”: 9 |
| }, ... | } |
| { | |
| “ds”: “2020-01-10”, | |
| “y”: 900 | |
| }, | |
| { | |
| “ds”: “2020-01-17”, | |
| “y”: 1130 | |
| }, | |
| { | |
| “ds”: “2020-01-24”, | |
| “y”: 800 | |
| }, | |
| { | |
| “ds”: “2020-01-24”, | |
| “y”: 1800 | |
| } | |
| ] | |
| } | |

The resource allocation system 1400 may include an anomaly detection service 1440. The anomaly detection service 1440 may include operations to identify resource allocations or transactions that may be infrequent or may be different based on a predefined set of attributes. For example, the anomaly detection service 1440 may conduct operations to identify that a value of a beverage purchase may be greater than a threshold value amount as compared to other purchases in a similar resource category.

In some embodiments, the anomaly detection service 1440 may include operations for identifying resource allocations that may be an anomalous resource transaction on a per-user transaction basis. As described herein, conducting operations on a per-user basis, as opposed to a global basis for a complete set of users, may be beneficial for expediently determining resource availability projections and within a threshold period of time of receiving user input associated with a prospective resource transaction.

In some embodiments, the anomaly detection service 1440 may include operations based on unsupervised learning operations, such as isolation forests. In some scenarios, it may be beneficial to conduct operations on a user-by-user basis and without batch training operations for expediently determining resource availability projections within a threshold period of time. As described herein, while determined projected resource availability can be valuable for providing “sober second thought” information to a user prior to allocating targeted resources, the value of the resource availability projections may be greater when expediently provided within a threshold period of time.

To illustrate an embodiment of the anomaly detection service 1440, Table 12 (below) outlines definitions of an example data structure that may be received as an input request for operations of the anomaly detection service 1440.

TABLE 12
Example data structure definitions for input request to anomaly detection operations

| Element | Description | Example |
|---|---|---|
| anomalyFromDate | Date, | ″2019-02-28″ |
| | Date to show anomalies from. If any were found. | |
| | Defaults to min dataset date. | |
| contamination | Float in (0., 0.5), The proportion of outliers in the | .005 |
| | data set Defaults to .001 | |
| outputAnomaly | String, ″True″ or ″False″, Defaults to ″True″. | ″True″ |
| | Indicating whether to perform and output anomaly | |
| | detection or not. | |
| explain | String, ″True″ or ″False″, Defaults to ″False″. | ″False″ |
| | Indicating whether to output anomaly detection | |
| | details. | |
| outputNew | String, ″True″ or ″False″, Defaults to ″False″. | ″False″ |
| | Indicating whether to perform and output new | |
| | merchants detection or not. | |
| data | | |
| -accountID | Single valued, ″string″ | ″65457324″ |
| -container | Single valued, ″string″ | ″creditCard″ |
| -txnDate | Date | ″2019-02-28″ |
| -txnAmount | Integer | ″212.34″ |
| | This data element tells the engine the number of | |
| | months in future to be predicted | |
| -txnCurrency | String | ″CA″or ″CAD″ or |
| | Should be consistent per account | ″Canadian″ or other |
| | | Distinct values expected |
| -baseType | String | ″DEBIT″ |
| | DEBIT or CREDIT | |
| -txnCategory | Integer | ″12″ |
| -txnSubCategory | String | ″AUTO_LOAN″ |
| -descSimple | Description Simple (A more generic category of | ″Salary″ |
| | description — i.e., ‘Paycheck/Salary’ --> ‘Salary’). | |
| | descSimple can also be a simplified description of | |
| | the merchantName | |

Table 13 illustrates an example input request associated with operations of the anomaly detection service 1440 and an example output associated with operations of the anomaly detection service 1440.

TABLE 13
Example input and output associated with operations of the anomaly detection service 1440

| Sample Request | Sample Response |
|---|---|
| { | |
| “contamination”: 0.01, | { |
| “anomalyFromDate”: “2017-08-01”, | “anomalies”: [ ], |
| “outputAnomaly”: “True”, | “new”: [ |
| “outputNew”: “True”, | { |
| “explain”: “False”, | “accountID”: “6947737”, |
| “data”: [ | “baseType”: “DEBIT”, |
| { | “container”: “creditCard”, |
| “accountID”: “6947737”, | “descSimple”: “STARBUCKS |
| “container”: “creditCard”, | 04817”, |
| “baseType”: “DEBIT”, | “txnAmount”: 11.3, |
| “txnDate”: “2018-08-17”, | “txnCategory”: “1003”, |
| “txnAmount”: 11.3, | “txnCurrency”: “CAD”, |
| “txnCurrency”: “CAD”, | “txnDate”: “Fri, 17 Aug 2018 |
| “txnCategory”: “1003”, | 00:00:00 GMT”, |
| “txnSubCategory”: “5138”, | “txnSubCategory”: “5138” |
| “descSimple”: “STARBUCKS 04817” | } |
| } | ] |
| ] | } |
| } | |

In some embodiments, the resource allocation system 1400 may include a data-cleansing service 1450. The data-cleansing service 350 may include operations for re-formatting data entries or descriptors. For example, the text string ‘Spotify #1234’ may be reformatted as a text string “SPOTIFY”. The text string “APL*ITUNES.com/BILL 555-555-5555 ON” may be reformatted as a text string “iTunes”. In some embodiments, merchant name extraction/simplification/reformatting may be based on learning models identifying patterns. Other operations of the data-cleansing service 1450 for filtering or reformatting resource data set portions received from the data source devices 1460 may be contemplated.

In some embodiments, one or more of the recurring transaction service 1420, the time-series forecasting service 1430, the anomaly detection services 1440, or the data cleansing service 1450 may be modular applications and, in some embodiments, a processor may conduct operations to conduct operations of the above-mentioned modular applications without conducting operations associated with the model orchestrator 1410.

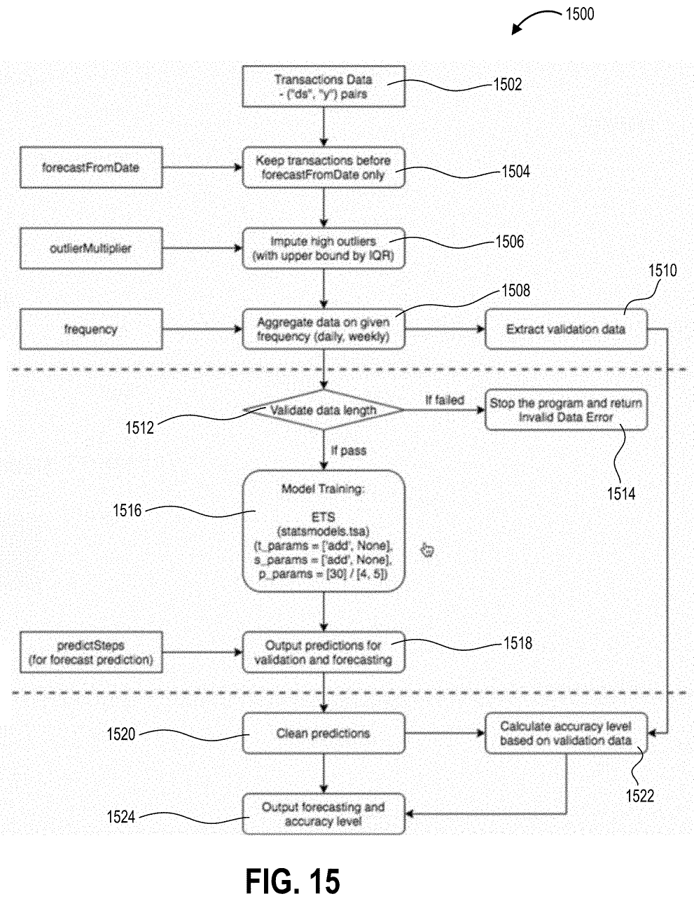

To illustrate example features of the time-series forecasting service 1430 of FIG. 14, in the present application, reference is made to FIG. 15, which illustrates a flowchart of a method 1500 of predicting or forecasting future resource allocations or resource transactions of a user, in accordance with an embodiment of the present disclosure. The method 1500 may be conducted by the processor 102 of the system 100 (FIG. 1) or of the processors of the described systems in FIG. 11, 12, or 13, among other example systems. The processor readable instructions may be stored in a memory and may be associated with the resource allocation application 112 or other applications not illustrated in FIG. 1.

At 1502, the processor may obtain transaction data from one or more data sources. As an illustrating example, the transaction data may be a series of data entries having the format (transaction date stamp (ds), transaction value (y)) to provide a transaction data entries. Other transaction data formats may be contemplated.

In some embodiments, the processor may conduct operations to process the obtained transaction data. For example, the transaction data may include data entries that may be incomplete (e.g., null values, missing values, etc.), may include data entries having undesirable outlier data, or may include data entries that may be outside a predefined scope for the resource allocation forecasting.

For example, at 1504, the processor may conduct operations to retain transaction data entries that are associated with a date value that is prior to a date associated with a variable “forecastFromDate”.

At 1506, the processor may conduct operations to identify outlier data entries based on an interquartile range analysis, and may conduct operations to disregard identified undesirable outlier data entries. In some embodiments, operations to identify outlier data entries may be based on an “outlierMultiplier” parameter (described in an example of the present application) in combination with an interquartile range analysis.

At 1508, the processor may conduct operations to aggregate or group data entries based on a desirable time frequency (e.g., daily, weekly, bi-weekly, monthly, etc).

In some embodiments, the processor may conduct other operations to pre-process obtained transaction data prior to conducting operations to forecast or predict future resource allocations.

At 1510, the processor may allocate a subset of the pre-processed data entries as a training data set and a subset of the pre-processed data entries as a validation data set. The training data set may include data entries for training a learning model.

The validation data set may be a portion of the pre-processed transaction data that may be used to provide an unbiased evaluation of the trained model following processing of the training data set in downstream operations. In some examples, the processor may also tune learning model hyper-parameters based on the validation data set. At 1522, the processor may determine resource allocation forecasting accuracy based on the validation data set.

At 1512, the processor may determine whether a data length of pre-processed data entries may correspond to a predefined data length. In some embodiments, operations for forecasting future resource allocations may include machine learning models having specified data length requirements. Accordingly, when the processor determines that a data length of a pre-processed data entry may not correspond to a predefined data length, the processor may, at 1514, generate a data error message and halt operations for forecasting resource allocations at a future point in time.

At 1516, the processor may conduct operations of a learning model for determining forecasted resource allocations. In some embodiments, the learning model may be based on operations of exponential smoothing for smoothing time-series data based on an exponential window function. For instance, exponential functions may be used to associate exponentially decreasing weights over time (whereas operations of a simple moving average may highlight past observations weighted equally). For example, operations of exponential smoothing may be based on a holt winters smoothing model and having features for trend and seasonality parameters. The smoothing model may be based on parameters (t, s, p), where t may indicate whether there is a trend, s may indicate whether there may be seasonality, and p may refer to a number of periods in each season. To illustrate, operations based on exponential smoothing may be based on: “t_params=[‘add’, None], s_params=[‘add’, None], p_params=[30]/[4,5]).

In some embodiments, the processor, at 1516, may conduct operations of other learning models. For example, the processor may conduct operations based on an autoregressive integrated moving average (ARIMA) model, which may be a generalization of an autoregressive moving average (ARMA) model. The ARIMA model may be fitted to time-series data for determining characteristics of the data or to forecast future data points in the time-series data. In some examples, ARIMA models may be applied in situations of non-stationarity, where initial differencing step may be applied one or more times to reduce non-stationarity. In some examples, the ARIMA model may be based on parameters: (p, d, q), where p may be the order (number of time lags) of the autoregressive model, d may be the degree of differencing (the number of times the data have had past values subtracted), and q may be the order of the moving-average model.

In some embodiments, the processor, at 1516, may conduct operations of an ARIMA model with seasonal ARIMA, where seasonal ARIMA may add seasonal effects (seasonality to ARIMA models). The seasonal ARIMA model may be based on (p,d,q)(P,D,Q)ₘ, where m refers to the number of periods in each season, and the uppercase P,D,Q refer to the autoregressive, differencing, and moving average terms for the seasonal part of the ARIMA model.

In some embodiments, the processor, at 1516, may conduct operations of a curve fitting model (e.g., PROPHET forecasting model) for forecasting time-series data based on an additive model. The curve fitting model may be based on an additive model where non-linear trends are fit with yearly, weekly, and daily seasonality, plus holiday effects. In some situations, the curve fitting model may be suitable when time series data have strong seasonal effects, and when the time series data includes multiple seasons of historical data. In some scenarios, the curve fitting model may be suitable when missing data, data trend shifts, or outliers data entries are present.

In some embodiments, the processor, at 1516, may conduct operations of a transformation and regression model (e.g., TBATS). The transformation and regression model may be a time-series model having one or more complex seasonalities, and having features including: trigonometric regressors to model multiple-seasonalities, box-cox transformations, ARMA errors, trends, and/or seasonality. In some examples, the TBATS model may be based on ;default parameters of a TBATS model.

In some embodiments, the processor may conduct operations of one or a combination of the learning models described herein. In embodiments when the processor may conduct operations of two or more learning models in parallel, the processor may conduct operations for comparing the results of the respective learning models and identifying the output from one of the learning models as most desirable based on an evaluation criterion. The evaluation criterion may be based on validation data identified at 1510.

In some embodiments, the time-series forecasting service 1430 may include operations for: identifying outlier data entries, determining data entry mean values, grouping transactions based on frequency periods (e.g., weekly, bi-weekly, etc.), imputing data entries as “0” where data entries may be missing, or conducting operations of multiple learning models in parallel for providing predictions and identifying a “best case” forecast output based on previously identified evaluation data sets.

At 1518, the processor may identify output predictions for validation and resource allocation forecasting based on learning model outputs.

At 1520, the processor may pre-process the output predictions. In some embodiments, pre-processing the output predictions may include transforming the output predictions into a desired data format for comparison with previously identified validation data.

At 1522, the processor may determine an accuracy level of output predictions based on previously identified validation data.

At 1524, the processor may generate a resource allocation forecast. In some embodiments, the processor may associate an accuracy level measure to indicate a confidence level of the resource allocation forecast to a user.

Reference is made again to FIG. 11. In some embodiments, a resource prediction system 1100 may include operations for generating and training a plurality of machine learning models 1120. The plurality of machine learning models 1120 may include one or more of operations of exponential smoothing model, autoregressive integrated moving average (ARIMA) model, curve fitting model (e.g., PROPHET forecasting model), transformation and regression model (TBATS), among other examples of models. It may be beneficial to configure systems to generate, train, and execute operations of a plurality of machine learning models in parallel, thereby providing features for monitoring performance of the resource prediction system 1100 and selecting prediction outputs that adhere to required system performance metric.

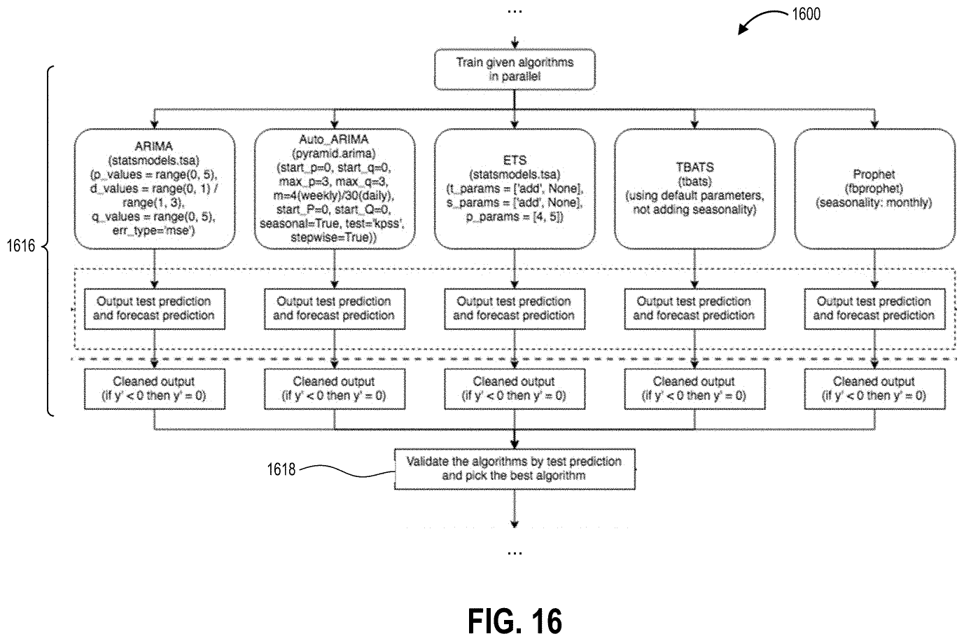

Reference is made to FIG. 16, which illustrates a partial flow chart of operations of a method 1600 of predicting or forecasting future resource allocations associated with a user, in accordance with embodiments of the present disclosure.

At operation 1616, a processor may train a generate, train, and execute operations of a plurality of machine learning models in parallel. For example, operation 1616 may correspond to examples of generating and training machine learning models 1120 and executing operations of stored models 1130 illustrated in FIG. 11. In some embodiments, operation 1616 may augment operation 1516 of the method 1500 of FIG. 15.

At operation 1618, the processor may conduct operations to validate the machine learning models based on prior-generated validation data sets and may conduct operations to pick prediction output based on a machine learning model having a highest evaluated performance based on performance monitoring operations 1150 (FIG. 11).

Where one or more machine learning model operations at 1616 generate prediction output not having evaluated performance that meets a particular threshold value, in some embodiments, a processor may be configured to trigger re-training of identified learning machine models not meeting performance criteria (e.g., meeting a particular threshold value). Such re-training operations may be associated with the training of machine learning models illustrated at 1120 of FIG. 11 and, subsequently, propagating such re-trained operations to the stored models at 1130 of FIG. 11. By monitoring performance of a plurality of machine learning models operating in parallel for generating predicted resource allocation output, embodiments of systems described herein may: (1) determine prediction outputs based on model output identified as having the most desirable output accuracy; and (2) dynamically and iteratively improve prediction models over time.

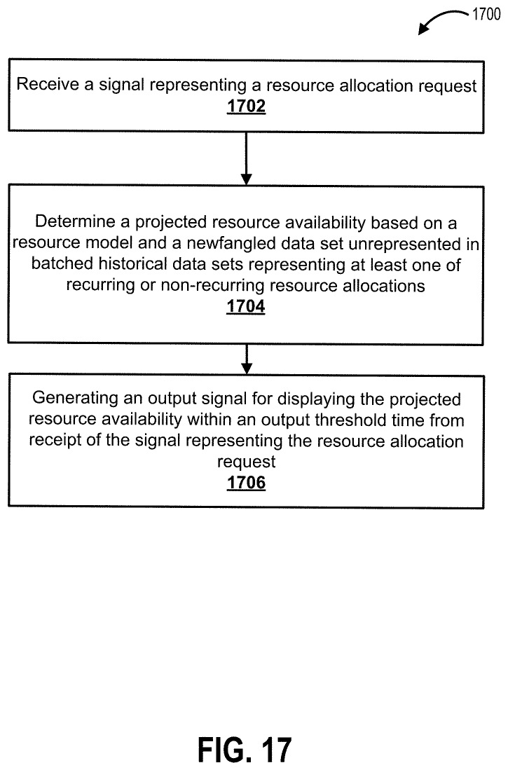

Reference is made to FIG. 17, which illustrates a method 1700 of dynamic resource allocation, in accordance with embodiments of the present disclosure. The method 1700 may be conducted by the processor 102 of the system 100 (FIG. 1). Processor-executable instructions may be stored in the memory 106 and may be associated with the machine-learning application 112 or other processor-executable applications not illustrated in FIG. 1. The method 1700 may include operations such as data retrievals, data manipulations, data storage, or other operations, and may include computer-executable operations.

To illustrate features of embodiments of the method 1700, the following description is based on examples of a user associated with a client device operating a resource allocation application, such as a mobile banking application provided by a banking institution. In some embodiments, the resource allocation application may provide a user interface (e.g., FIG. 2 and FIG. 4) for displaying resource availability associated a user identifier of the client device.

At operation 1702, the processor may receive a signal representing a resource allocation request. In some embodiments, the signal representing the resource allocation request may be based on receiving an activation signal at an interactive user interface element displayed at the client device. For example, a user of the client device may provide touchscreen input at the user interface of FIG. 4 for indicating a resource value (e.g., dollar amount) that the user would like to spend.

In some embodiments, the signal representing the resource allocation request may include a signal representing a pending resource allocation value received from a point-of-sale device. For example, the client device may detect a signal via near-field communication from an point-of-sale terminal at a payment register at a brick-and-mortar store, and the signal may represent purchase price of products being inputted into a payment system. The signal representing the projected purchase may provide a basis for proactively providing a projected resource availability if the user approves the purchase authorization (e.g., submits a personal identification number (PIN), provides a biometric input to signal approval, etc.). In a subsequent operation, providing a projected resource availability notification may provide the user of the client device with an opportunity to consider whether any future resource deficiencies for that user may occur.

In some embodiments, the signal representing the resource allocation request may include a detection of a push notification, at the client device, representing a targeted resource allocation request at an external resource allocation provider. As an example, the push notification may be provided by a credit card company that is unrelated to the above-described banking institution. The banking institution may be the user's primary banking institution. As the targeted resource allocation request may be a credit card purchase that may impact the user's future resource availability (e.g., cash flow), embodiments of the present disclosure may be configured to detect or consider such push notifications that may be detected at the client device.

In some embodiments, the signal representing the resource allocation request may be based on detection of a series of resource allocations within a recent time range for forecasting future resource allocation requests. For example, detection of the series of resource allocations within a recent time range may be a set of proactive operations for identifying that a user may be at a shopping mall and making series of purchases in a short period of time (e.g., rapid succession).

In some situations, it may be beneficial to utilize such detection of the series of resource allocations in a short period of time to pre-emptively trigger operations for determining a projected resource availability for the user, thereby providing the user with an opportunity to consider whether there may be future resource deficiencies for that user in view of the detected spending trends. For example, a defined prior time range may be within 60 minutes, and in scenarios where the system detects that a series of resource allocations (e.g., product purchases) have been made within the last 60 minutes, it may be beneficial to pre-emptively provide projected resource availability indications to a user to proactively notify of potential over-spending.

At operation 1704, the processor may determine a projected resource availability based on a resource model and a second data set including at least one data record unrepresented in batched historical data sets. The batched historical data sets including data records representing at least one of recurring or non-recurring resource allocations. The resource model may have been prior-trained based on the batched data sets.

As an example, the batched historical data sets may include comprehensive data sets associated with resource allocation transactions associated with a plurality of banking customers. The batched historical data sets may have been prior-processed for downstream computing operations, and may represent resource transaction data as current as the latest date/time stamp associated with the data set.

In some situations, the batched historical data sets may only be as current as when the batched data sets were combined and processed (e.g., 11:59 pm daily). Accordingly, determining the projected resource availability based on fresh data sets (e.g. resource transactions conducted at 9 am the following day) may provide fresh or real-time data for providing as accurate a projected resource availability (e.g., liquidity position) as possible.

In some embodiments, the fresh data set (e.g., a second data set) may include at least one data record (e.g., timestamped at 9 am, on a day subsequent to the 11:59 pm timestamp of batched data sets) that may be unrepresented in batched historical data sets. Operations for training machine learning models may be computationally intensive and may be time consuming sets of operations. In some situations, it may not be practical to re-train resource models (e.g., stored models 1130 of FIG. 11) based on a fresh data set for providing an up-to-date projected resource availability indication. Thus, embodiments of systems and methods described in the present disclosure include operations of a hybrid approach for generating projected resource availability indications within a timely fashion (e.g., within 3 seconds of receiving a signal representing a resource allocation request). For instance, operations of the hybrid approach may include taking into account batched historical data sets and fresh data sets (e.g., including data records unrepresented in batched historical data sets).

In some embodiments, the fresh data sets may include data records that represent resource allocation transactions that may be timestamped: (i) after a timestamp of the batched data sets; and (ii) before operations of the system to include such data records in a subsequent batched data set (e.g., time stamped at 11:59 pm of a subsequent day). Above described examples describe operations for generating batched data sets “once a day, at 11:59 pm”; however, other frequency intervals for incorporating fresh data sets into batched data sets may be used.

In some embodiments, the batched historical data sets may be comprehensive data sets that are associated on a user-by-user basis. For example, the batched historical data sets may represent recurring or non-recurring resource allocations for a particular user identifier, such that operations may be conducted for generating projected resource availability based on historical data sets of that particular user.

In some situations, data sets associated with particular users may not have sufficient data records to provide optimal resource availability projections for that user. Thus, in some embodiments, batched historical data sets for particular users may be combined with batched historical data sets with a larger set of users. In some embodiments, the processor may retrieve batched historical data sets of a larger set of user identifiers having a user profile similar to that of the above-described first/particular user.

In some embodiments, the resource model includes a plurality of discrete machine learning models executable in parallel for generating an array of projected resource availability values. Referring again to FIG. 16, the resource model may include one or more of the ARIMA, AutoARIMA, ETS, TBATS, or Prophet models for generating projected resource availability values. In some embodiments, the processor may conduct operations to validate the respective model outputs based on a validation data set and identify a most optimal output value for downstream computing operations.

In some embodiments, determining the projected resource availability includes combining the respective projected resource availability values of the array based on weights. For example, the processor may assign a weight value of “1.0” to a most optimal output value and a value of “0.0” for all other projected resource availability output values. In some other examples, the processor may assign fractional weight values to two or more of the projected resource availability values, and combine the plurality of weighted values for downstream computing operations.

In some embodiments, upon conducting operations to validate the respective model outputs and identifying at least one projected resource availability being a sub-optimal projected resource availability output, the processor may be configured to re-train at least one of the plurality of discrete machine learning models based on the second data set. The operations to validate the respective model outputs may be based on performance monitoring operations 1150 described with reference to FIG. 11. In some embodiments, validating operations may be based on metrics such as mean absolute percentage error (MAPE), thereby providing for descriptive reporting and analysis of model performance and providing for model decay.

In some embodiments, the signal representing the resource allocation request may include a date/time value for determining the projected resource availability. For example, the time value may be a user provided date as of which the user would like to know the projected resource availability. For example, the user may wish to understand the user's cash flow as of September 15 and may provide the date/time value a user interface of the client device. Accordingly, operations for determining the projected resource availability may include time-shifting the projected resource availability to the prospective time.

At operation 1706, the processor may generate an output signal for displaying the projected resource availability corresponding with the resource allocation request. In some embodiments, the output signal may be for displaying embodiments of the user interface displayed at FIG. 2 or FIG. 4. In some embodiments, the user interface may include non-textual user interface elements including a color gradient along non-textual display elements for illustrating transitions among projected resource availability thresholds. For example, as described with reference to FIGS. 3 and 4, a colour gradient may include colors such as green, yellow, or red, and the non-textual user interface element may transition from green to yellow when a projected resource availability decreases in value by 40%, and may transition from yellow to red when the projected resource availability decreases in value by 70% or more. Other user interfaces may be contemplated.

In some embodiments, the output signal may be provided within an output threshold time from receipt of the signal representing the resource allocation request. As the value of providing the projected resource availability to the user at the client device may be increased when provided in a timely fashion (e.g., within a threshold period of time of 3 seconds, among example time periods), the output signal may potentially providing users with “sober second thought” information to executing data processes to allocate resource allocations (e.g., making purchases). Thus, pre-emptively providing projected resource availability feedback at the client device may be beneficial.

In some embodiments, the output signal for displaying the projected resource availability may include a signal for providing haptic feedback at the client device representing the projected resource availability thresholds. Continuing with the above-described example, a haptic feedback (e.g., vibratory alert, among other examples) at the client device for a specified duration of time may represent the decrease in projected resource availability value by 40%, and a patterned haptic feedback alert may represent the decrease in projected resource availability value by 70% or more. Other types of feedback alerts at the client device may be contemplated.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present disclosure is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

The description provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

As can be understood, the examples described above and illustrated are intended to be exemplary only.

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

What is claimed is:

1. A system of dynamic resource allocation comprising:
a processor;
a memory coupled to the processor and storing processor-executable instructions that, when executed, configure the processor to:
receive a signal representing a resource allocation request;
determine a projected resource availability based on a resource model and a second data set including at least one data record unrepresented in batched historical data sets, the batched historical data sets including data records representing at least one of recurring or non-recurring resource allocations, and wherein the resource model is prior-trained based on the batched historical data sets; and
generate an output signal for displaying the projected resource availability corresponding with the resource allocation request.

2. The system of claim 1, wherein the output signal is provided within an output threshold time from receipt of the signal representing the resource allocation request.

3. The system of claim 1, wherein the signal representing the resource allocation request includes a signal representing a pending resource allocation value received from a point-of-sale device.

4. The system of claim 1, wherein the signal representing the resource allocation request includes detection of a notification at a client device representing a targeted resource allocation request at an external resource allocation provider.

5. The system of claim 1, wherein the signal representing the resource allocation request is based on receiving an activation signal at an interactive user interface element displayed at a client device, the activation signal based on sliding user input along a user interface element in a first direction.

6. The system of claim 1, wherein the signal representing the resource allocation request is based on detection of a series of resource allocations within a defined prior time range for forecasting further resource allocation requests.

7. The system of claim 1, wherein the second data set includes pre-authorization requests for resource allocations unrepresented in the batched historical data sets.

8. The system of claim 1, wherein the resource model includes a plurality of discrete machine learning models executable in parallel for generating an array of projected resource availability values,
and wherein determining the projected resource availability includes combining the respective projected resource availability values of the array based on weights.

9. The system of claim 1, wherein the processor-executable instructions, when executed, configure the processor to:
identify, based on a validation data set derived from batched historical data sets, at least one projected resource availability value being a sub-optimal projected resource availability output; and
re-training at least one of the plurality of discrete machine learning models based on the second data set.

10. The system of claim 1, wherein the resource allocation request represents a prospective time for determining the projected resource availability, and wherein determining the projected resource availability includes time-shifting the projected resource availability to the prospective time.

11. The system of claim 1, wherein the resource allocation request is associated with a first user identifier, and wherein the second data set represents recurring or non-recurring resource allocations associated with a second user identifier having a user profile substantially similar to the first user identifier.

12. The system of claim 1, wherein the output signal for displaying the projected resource availability includes a signal for providing haptic feedback at a client device representing a projected resource availability threshold.

13. A method of dynamic resource allocation comprising:
receiving a signal representing a resource allocation request;
determining a projected resource availability based on a resource model and a second data set including at least one data record unrepresented in batched historical data sets, the batched historical data sets including data records representing at least one of recurring or non-recurring resource allocations, and wherein the resource model is prior-trained based on the batched historical data sets; and
generating an output signal for displaying the projected resource availability corresponding with the resource allocation request.

14. The method of claim 13, wherein the output signal is provided within an output threshold time from receipt of the signal representing the resource allocation request.

15. The method of claim 13, wherein the signal representing the resource allocation request includes a signal representing a pending resource allocation value received from a point-of-sale device.

16. The method of claim 13, wherein the signal representing the resource allocation request includes detection of a notification at a client device representing a targeted resource allocation request at an external resource allocation provider.

17. The method of claim 13, wherein the signal representing the resource allocation request is based on receiving an activation signal at an interactive user interface element displayed at a client device, the activation signal based on sliding user input along a user interface element in a first direction.

18. The method of claim 13, wherein the signal representing the resource allocation request is based on detection of a series of resource allocations within a defined prior time range for forecasting further resource allocation requests.

19. The method of claim 13, wherein the resource allocation request represents a prospective time for determining the projected resource availability, and wherein determining the projected resource availability includes time-shifting the projected resource availability to the prospective time.

20. A non-transitory computer-readable medium having stored thereon machine interpretable instructions which, when executed by a processor, cause the processor to perform a computer implemented method comprising:
receiving a signal representing a resource allocation request;
determining a projected resource availability based on a resource model and a second data set including at least one data record unrepresented in batched historical data sets, the batched historical data sets including data records representing at least one of recurring or non-recurring resource allocations, and wherein the resource model is prior-trained based on the batched historical data sets; and
generating an output signal for displaying the projected resource availability corresponding with the resource allocation request.
